(19) United States
(12) Patent Application Publication
(10) Pub. No.: US 2024/0373441 A1
(43) Pub. Date: Nov. 7, 2024

(54) METHOD AND APPARATUS FOR DETERMINING RESOURCE BLOCK SET IN WIRELESS COMMUNICATION SYSTEMS

(71) Applicant: Samsung Electronics Co., Ltd., Gyeonggi-do (KR)

(72) Inventors: Kyungjun CHOI, Gyeonggi-do (KR); Youngrok JANG, Gyeonggi-do (KR); Hyoungju JI, Gyeonggi-do (KR)

(21) Appl. No.: 18/654,854

(22) Filed: May 3, 2024

(30) Foreign Application Priority Data
May 4, 2023 (KR) 10-2023-0058750

(51) Int. Cl. H04W 72/232; H04L 5/00

(52) U.S. Cl. CPC H04W 72/232; H04L 5/0053

(57) ABSTRACT

The disclosure relates to a 5G or 6G communication system for supporting a higher data transmission rate. A method performed by a terminal in a wireless communication system includes receiving, from the base station, a physical downlink control channel (PDCCH) including at least one control channel element (CCE), and identifying a resource block (RB) set for an uplink transmission based on the PDCCH in case that a CCE with a first lowest index is overlapped with a guard band in a plurality of RB sets.

### CROSS-REFERENCE TO RELATED APPLICATION(S)

This application is based on and claims priority under 35 U.S.C. § 119 to Korean Patent Application No. 10-2023-0058750, filed on May 4, 2023, in the Korean Intellectual Property Office, the disclosure of which is incorporated herein by reference in its entirety.

### BACKGROUND

### 1. Field

The disclosure relates generally to a wireless communication system, and more particularly, to a method and a device for determining a scheduled resource block (RB) set by a terminal in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A wireless communication system is advancing to a broadband wireless communication system for providing high-speed and high-quality packet data services using communication standards, such as high-speed packet access (HSPA) of the third generation partnership project (3GPP), LTE or evolved universal terrestrial radio access (E-UTRA)), TE-A, LTE-professional (Pro), high-rate packet data (HRPD) of 3GPP2, ultra-mobile broadband (UMB), institute of electrical and electronics engineers (IEEE) 802.16e, and the like, as well as typical voice-based services.

As an example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) or a mobile station (MS) transmits data or control signals to a base station (BS) (or eNode B), and the DL indicates a radio link through which the base station transmits data or control signals to the UE. This multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 gigabits per second (Gbps) in the downlink and a peak data rate of 10 Gbps in the UL for a single base station. The 5G communication system must provide an increased user-perceived data rate to the UE, as well as the maximum data rate. To satisfy such requirements, improvements in transmission/reception technologies including a further enhanced multi-input multi-output (MIMO) transmission technique are needed. The data rate required for the 5G communication system may be obtained using a frequency bandwidth more than 20 megahertz (MHz) in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of things (IoT) in the 5G communication system. mMTC has requirements, such as support of connection of a large number of UEs in a cell, enhancement coverage of UEs, improved battery time, a reduction in the cost of a UE, and the like, to effectively provide the Internet of things (IoT). Since the IoT provides communication functions while being provided to various sensors and various devices, the IoT must support a large number of UEs (e.g., 1,000,000 UEs/squared kilometer (km2)) in a cell. The UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a long battery life-time, such as 10 to 15 years, since it is difficult to frequently replace the battery of the UE.

URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) less than those of other services, and also may require a design for assigning a large number of resources in a frequency band to secure reliability of a communication link.

The three services in 5G, that is, eMBB, URLLC, and mMTC, may be multiplexed and transmitted in a single system. In this case, different transmission/reception techniques and transmission/reception parameters may be used between services to satisfy different requirements of the respective services.

Repeated physical downlink control channel (PDCCH) transmission is not supported currently in release (Rel)-15 and Rel-16 of the NR standard, and it is thus difficult to achieve required reliability in a scenario requiring high reliability, such as URLLC. Thus, there is a need in the art for a method of repeated PDCCH transmission via multiple transmission and reception points (TRPs) to improve PDCCH reception reliability of a terminal.

Moreover, with the advance of wireless communication systems as described above, various services can be provided. Thus, there is a need in the art for a manner in which to smoothly provide these services.

### SUMMARY

The disclosure has been made to address at least the above-mentioned problems and/or disadvantages and to provide at least the advantages described below.

Accordingly, an aspect of the disclosure is to provide a device and a method capable of effectively providing a service in a mobile communication system.

An aspect of the disclosure is to provide a method and apparatus by which misunderstandings between the base station and the terminal due to ambiguity in a PDCCH blind decoding method used by the terminal may be rectified.

An aspect of the disclosure is to provide a method by which, when a downlink control information (DCI) format for scheduling of a physical uplink control channel (PUSCH) is received, a base station determines an RB set in which the PUSCH is scheduled.

In accordance with an aspect of the disclosure, a method performed by a terminal in a wireless communication system includes receiving, from the base station, a physical downlink control channel (PDCCH) including at least one control channel element (CCE), and identifying a resource block (RB) set for an uplink transmission based on the PDCCH in case that a CCE with a first lowest index is overlapped with a guard band in a plurality of RB sets.

In accordance with an aspect of the disclosure, a method performed by a base station in a wireless communication system includes transmitting, to a terminal, a physical downlink control channel (PDCCH) including at least one control channel element (CCE), wherein a resource block (RB) set for an uplink transmission is based on the PDCCH in case that a CCE with a first lowest index is overlapped with a guard band in a plurality of RB sets.

In accordance with an aspect of the disclosure, a terminal in a wireless communication system includes a transceiver, and at least one processor coupled with the transceiver and configured to receive, from the base station, a physical downlink control channel (PDCCH) including at least one control channel element (CCE), and identify a resource block (RB) set for an uplink transmission based on the PDCCH in case that a CCE with a first lowest index is overlapped with a guard band in a plurality of RB sets.

In accordance with an aspect of the disclosure, a base station in a wireless communication system includes a transceiver, and at least one processor coupled with the transceiver and configured to transmit, to a terminal, a physical downlink control channel (PDCCH) including at least one control channel element (CCE), wherein a resource block (RB) set for an uplink transmission is based on the PDCCH in case that a CCE with a first lowest index is overlapped with a guard band in a plurality of RB sets.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment;

FIG. 2 illustrates a structure of frames, subframes, and slots in a wireless communication system according to an embodiment;

FIG. 3 illustrates an example of configuration of a bandwidth part (BWP) in a wireless communication system according to an embodiment;

FIG. 4 illustrates an example of configuration of a control region of a downlink control channel in a wireless communication system according to an embodiment;

FIG. 5 illustrates a structure of a downlink control channel in a wireless communication system according to an embodiment;

FIG. 6 illustrates a method in which a base station and a UE transmit/receive data in view of a physical downlink shared channel (PDSCH) and a rate matching resource, according to an embodiment;

FIG. 7 illustrates an example of frequency domain resource assignment of a PDSCH or a PUSCH in a wireless communication system according to an embodiment;

FIG. 8 illustrates an example of allocation of time domain resources of a PDSCH in a wireless communication system according to an embodiment;

FIG. 9 illustrates an example of allocation of time domain resources according to subcarrier spacings of a data channel and a control channel in a wireless communication system according to an embodiment;

FIG. 10 illustrates radio protocol structures of a base station and a UE in single cell, carrier aggregation, and dual connectivity situations in a wireless communication system according to an embodiment;

FIG. 11 illustrates a resource block (RB) set according to an embodiment;

FIG. 12 illustrates scheduled RB set determination according to reception of a PDCCH according to an embodiment;

FIG. 13 illustrates when an RB set cannot be determined when a PDCCH is received according to an embodiment;

FIG. 14 illustrates downlink control information (DCI) length alignment according to an embodiment;

FIG. 15 illustrates a PDCCH candidate with AL 8 and a PDCCH candidate with AL 16 in one search space according to an embodiment;

FIG. 16 illustrates a PDCCH candidate with AL 8 and a PDCCH candidate with AL 16 in two linked search spaces according to an embodiment;

FIG. 17 illustrates subband non-overlapping full duplex (SBFD) operations according to an embodiment;

FIG. 18 illustrates a structure of a UE in a wireless communication system according to an embodiment; and

FIG. 19 illustrates a structure of a base station in a wireless communication system according to an embodiment.

### DETAILED DESCRIPTION

Hereinafter, embodiments of the disclosure will be described in detail with reference to the accompanying drawings. Accordingly, those of ordinary skill in the art will recognize that various changes and modifications of the embodiments described herein can be made without departing from the scope and spirit of the disclosure. Descriptions of well-known functions and constructions may be omitted for the sake of clarity and conciseness.

In the accompanying drawings, some elements may be exaggerated, omitted, or schematically illustrated.

The size of each element does not completely reflect the actual size. In the respective drawings, the same or corresponding elements are provided with the same or corresponding reference numerals.

Herein, the components included in the disclosure are expressed in a singular or plural form. However, the singular or plural expression is appropriately selected according to a situation for the convenience of explanation, the disclosure is not limited to a single component or a plurality of components, the components expressed in the plural form may be configured as a single component, and the components expressed in the singular form may be configured as a plurality of components.

Throughout the specification, the same or like reference signs indicate the same or like elements. The terms which will be described below are terms defined in consideration of the functions herein and may be different according to users, intentions of the users, or customs. Therefore, the definitions of the terms should be made based on the contents throughout the specification.

In the following description, a base station (BS) is an entity that allocates resources to terminals, and may be at least one of a gNode B, an eNode B, a Node B, a wireless access unit, a base station controller, and a node on a network. A terminal may include a user equipment (UE), a mobile station (MS), a cellular phone, a smartphone, a computer, or a multimedia system capable of performing a communication function. Herein a downlink (DL) refers to a radio link via which a base station transmits a signal to a terminal, and an uplink (UL) refers to a radio link via which a terminal transmits a signal to a base station. Long term evolution (LTE) or LTE-advanced (LTE-A) systems may be described herein by way of example, but the disclosure may also be applied to other communication systems having similar technical backgrounds or channel types. Examples of such communication systems may include 5G new radio (NR) which may cover the exiting LTE, LTE-A, and other similar services. In addition, based on determinations by those skilled in the art, the disclosure may be applied to other communication systems through some modifications without significantly departing from the scope of the disclosure.

Embodiments of the disclosure may be employed in frequency division duplex (FDD) and time division duplex (TDD) systems. As used herein, upper signaling (or upper layer signaling) is a method for transferring signals from a base station to a UE by using a DL data channel of a physical layer, or from the UE to the base station by using an UL data channel of the physical layer, and may also be referred to as RRC signaling, packet data convergence protocol (PDCP) signaling, or a medium access control (MAC) control element (MAC CE).

In the drawings, the order of the description does not always correspond to the order in which steps of each method are performed, and the order relationship between the steps may be changed or the steps may be performed in parallel. Alternatively, some elements may be omitted and only some elements may be included therein without departing from the essential spirit and scope of the disclosure. Furthermore, some or all of the contents of each embodiment may be implemented in combination without departing from the essential spirit and scope of the disclosure.

Herein, a unit refers to a software element or a hardware element, such as a field programmable gate array (FPGA) or an application specific integrated circuit (ASIC), which performs a predetermined function. However, the unit does not always have a meaning limited to software or hardware and may be constructed either to be stored in an addressable storage medium or to execute one or more processors. Therefore, the unit includes software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units or may be implemented to reproduce one or more central processing units (CPUs) within a device or a security multimedia card and the unit may include one or more processors.

### NR Time Frequency Resources

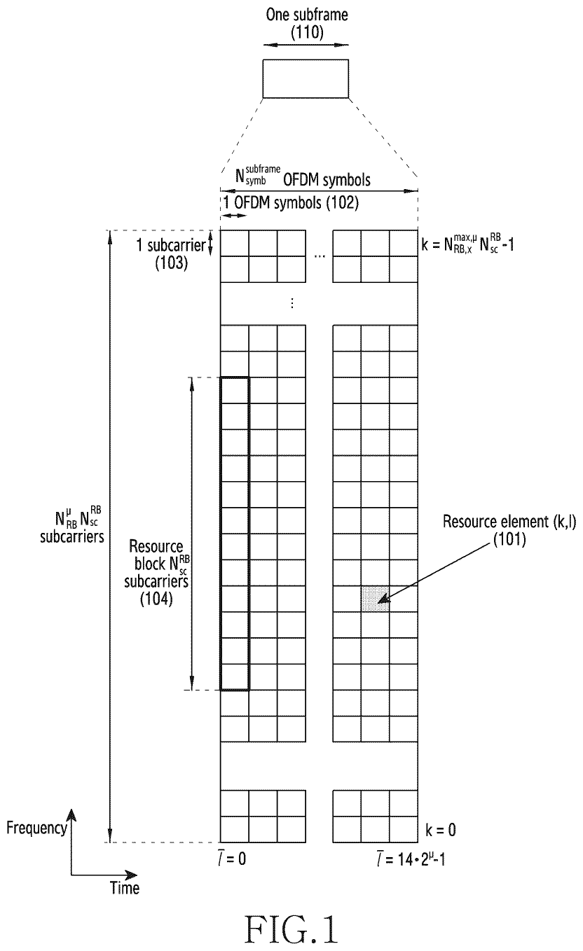

FIG. 1 illustrates a basic structure of a time-frequency domain in a wireless communication system according to an embodiment.

Referring to FIG. 1, a basic structure of a time-frequency domain, which is a radio resource domain used to transmit data or control channels in a 5G system, may be described.

In FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104.

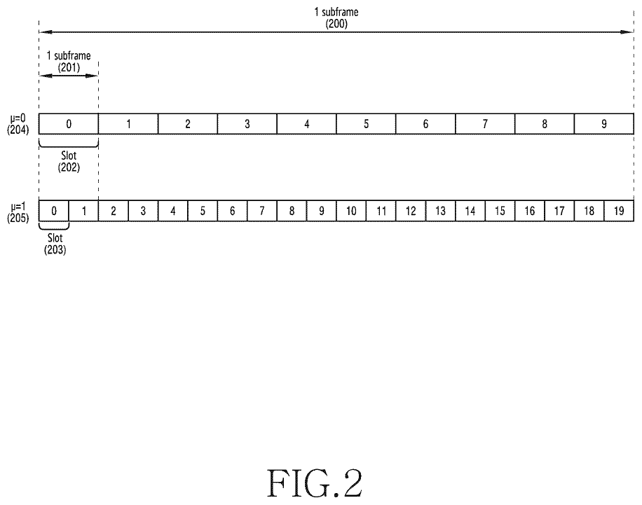

FIG. 2 illustrates a structure of frames, subframes, and slots in a wireless communication system according to an embodiment.

Referring to FIG. 2, a structure of a frame 200, a subframe 201, and a slot 202 is shown. Frame 200 may be defined as 10 ms. Subframe 201 may be defined as 1 ms. Therefore, frame 200 may include a total of ten subframes 201. Sot 202 or 203 may be defined as 14 OFDM symbols (that is, the number of symbols per one slot N_{symb}^{slot}=14). Subframe 201 may include one or multiple slots 202 and 203, and the number of slots 202 and 203 per one subframe 201 may vary depending on configuration values for the subcarrier spacing 204 or 205. The example in FIG. 2 illustrates when the subcarrier spacing configuration value is μ=0 (204), and when μ=1 (205). In the case of μ=0 (204), subframe 201 may include slot 202, and in the case of μ=1 (205), subframe 201 may include two slots 203. That is, the number of slots per one subframe Nₛₗₒₜ^{sunframe,μ} may differ depending on the subcarrier spacing configuration value μ, and the number of slots per one frame Nₛₗₒₜ^{frame,μ} may differ accordingly. Nₛₗₒₜ^{sunframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{sunframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### Bandwidth Part (BWP)

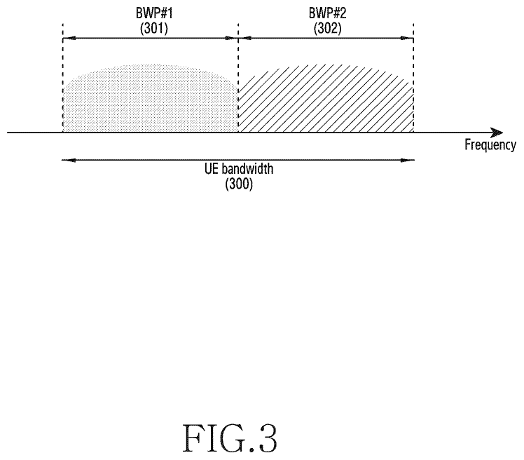

FIG. 3 illustrates an example of configuration of a BWP in a wireless communication system according to an embodiment;

Referring to FIG. 3, an example in which a UE bandwidth 300 is configured to include two BWPs, that is, BWP #1 301 and BWP #2 302, is illustrated. Abase station may configure one or multiple BWPs for a UE, and may configure the following pieces of information with regard to each BWP as shown in Table 2 below.

TABLE 2

| | |
|---|---|
| BWP ::= | SEQUENCE { |
| bwp-Id | BWP-Id, |

(BWP identifier)

| | |
|---|---|
| locationAndBandwidth | INTEGER (1..65536), |

(BWP location)

| | |
|---|---|
| subcarrierSpacing | ENUMERATED {n0, n1, n2, n3, n4, n5}, |

(subcarrier spacing)

| | |
|---|---|
| cyclicPrefix | ENUMERATED { extended } |

(cyclic prefix)
}

Various parameters related to the BWP may be configured for the UE, in addition to the above configuration information. The above pieces of information in Table 2 may be transferred from the base station to the UE through upper layer signaling, such as radio resource control (RRC signaling. One configured BWP or at least one BWP among multiple configured BWPs may be activated. Whether or not to activate a configured BWP may be transferred from the base station to the UE semi-statically through RRC signaling, or dynamically through DCI.

Before a RRC connection, an initial BWP for initial access may be configured for the UE by the base station through a master information block (MIB). That is, the UE may receive configuration information regarding a control region (for example, control resource set (CORESET)) and a search space, which may be used to transmit a PDCCH for receiving remaining system information (RMSI) or system information block 1 (SIB1) necessary for initial access, through the MIB in the initial access step. Each of the control resource set and the search space configured through the MIB may be configured as identity (ID) 0. The base station may transmit or deliver the UE of configuration information regarding control resource set #0, including at least one of frequency allocation information, time allocation information, and numerology, through the MIB. The base station may transmit or deliver the UE of configuration information regarding the monitoring cycle and occasion of control resource set #0, that is, configuration information regarding search space #0, through the MIB. The UE may consider that a frequency domain configured by control resource set #0 acquired from the MIB is an initial BWP for initial access. The ID of the initial BWP may be considered to be 0.

The BWP configuration supported by the 5G communication system, may be used for various purposes.

If the bandwidth supported by the UE is less than the system bandwidth, this may be supported through the BWP configuration. For example, the base station may configure the frequency location (for example, configuration information 2) of the BWP for the UE such that the UE can transmit/receive data at a specific frequency location within the system bandwidth.

The base station may configure multiple BWPs for the UE to support different numerologies. For example, to support a UE's data transmission/reception using both a subcarrier spacing of 15 kHz and a subcarrier spacing of 30 kHz, two BWPs may be configured as subcarrier spacings of 15 kHz and 30 kHz, respectively. Different BWPs may be subjected to frequency division multiplexing (FDM), and when data is to be transmitted/received at a specific subcarrier spacing, the BWP configured as the corresponding subcarrier spacing may be activated.

In addition, the base station may configure BWPs having different sizes of bandwidths for the UE for the purpose of reducing power consumed by the UE. For example, if the UE supports a substantially large bandwidth of 100 MHz and always transmits/receives data with the corresponding bandwidth, a substantially large amount of power consumption may occur. Particularly, it is inefficient for power consumption purposes to unnecessarily monitor the DL control channel with a large bandwidth of 100 MHz in the absence of traffic. To reduce power consumed by the UE, the base station may configure a BWP of a relatively small bandwidth of 20 MHz for the UE. The UE may perform a monitoring operation in the 20 MHz BWP in the absence of traffic, and may transmit/receive data with the 100 MHz BWP as instructed by the base station in the presence of data.

In connection with the BWP configuration method, UEs, before being RRC-connected, may receive configuration information regarding the initial BWP through an MIB in the initial access step. Specifically, a UE may have a control region (for example, a CORESET) configured for a DL control channel, which may be used to transmit DCI for scheduling an SIB, from the MIB of a physical broadcast channel (PBCH). The bandwidth of the control resource set configured by the MIB may be considered (or configured) as the initial BWP, and the UE may receive, through the configured initial BWP, a PDSCH through which an SIB is transmitted. The initial BWP may be used not only for the purpose of receiving the SIB, but also for other system information (OSI), paging, random access, or the like.

### BWP Change

If a UE has one or more BWPs configured therefor, the base station may instruct to the UE to change (or switch or transition) the BWPs by using a BWP indicator field inside DCI. As an example, if the currently activated BWP of the UE is BWP #1 301 in FIG. 3, the base station may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a PUSCH, and thus, upon receiving a BWP change request, the UE needs to be able to receive or transmit the PDSCH or PUSCH scheduled by the corresponding DCI in the changed BWP. To this end, requirements for the delay time (TBWP) required during a BWP change are specified in standards, and may be defined as in Table 3 below.

TABLE 3

| | |
|---|---|
| NR Slot length | BWP switch delay T_{BWP} (slots) |

| μ | (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirements for the BWP change delay time may support type 1 or type 2, depending on the capability of the UE. The UE may report the supportable BWP delay time type to the base station.

If the UE has received DCI including a BWP change indicator in slot n, according to the above-described requirement regarding the BWP change delay time, the UE may complete a change to the new BWP indicated by the BWP change indicator at a timepoint not later than slot n+TBWP, and may transmit/receive a data channel scheduled by the corresponding DCI in the newly changed BWP. If the base station wants to schedule a data channel by using the new BWP, the base station may determine time domain resource allocation regarding the data channel in consideration of the UE's BWP change delay time (TBWP). That is, when scheduling a data channel by using the new BWP, the base station may schedule the corresponding data channel after the BWP change delay time, in connection with the method for determining time domain resource allocation regarding the data channel. Accordingly, the UE may not expect that the DCI that indicates a BWP change will indicate a slot offset (K0 or K2) value less than the TBWP.

If the UE has received DCI (for example, DCI format 1_1 or 0_1) indicating a BWP change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K (that is, the last symbol of slot n+K−1).

### Synchronization Signal (SS)/PBCH Block

An SS/PBCH block may refer to a physical layer channel block including a primary SS (PSS), a secondary SS (SSS), and a PBCH. Details thereof may be as follows:

PSS: a signal which becomes a reference of DL time/frequency synchronization, and provides partial information of a cell ID.

SSS: becomes a reference of DL time/frequency synchronization, and provides remaining cell ID information not provided by the PSS. Additionally, the SSS may play the role of a reference signal for PBCH demodulation.

PBCH: provides essential system information necessary for the UE's data channel and control channel transmission/reception. The essential system information may include search space-related control information indicating a control channel's radio resource mapping information, scheduling control information regarding a separate data channel for transmitting system information, and the like.

SS/PBCH block: the SS/PBCH block includes a combination of a PSS, an SSS, and a PBCH. One or more SS/PBCH blocks may be transmitted within a time period of 5 ms, and each transmitted SS/PBCH block may be distinguished by an index.

The UE may detect the PSS and the SSS in the initial access stage, and may decode the PBCH. The UE may acquire an MIB from the PBCH, and this may be used to configure CORESET #0 (for example, corresponding to a control resource set having a control resource set index of 0). The UE may monitor control resource set #0 by assuming that the demodulation reference signal (DMRS) transmitted in the selected SS/PBCH block and control resource set #0 is quasi-co-located (QCL). The UE may receive system information through DL control information transmitted in control resource set #0. The UE may acquire configuration information related to a random access channel (RACH) necessary for initial access from the received system information. The UE may transmit a physical RACH (PRACH) to the base station in consideration of a selected SS/PBCH index, and the base station, upon receiving the PRACH, may acquire information regarding the SS/PBCH block index selected by the UE. The base station may know which block the UE has selected from respective SS/PBCH blocks, and since control resource set #0 associated therewith is monitored.

PDCCH: regarding DCI

In a 5G communication system, scheduling information regarding a PUSCH or a PDSCH is transferred from a base station to a UE through DCI. The UE may monitor, with regard to the PUSCH or PDSCH, a fallback DCI format including a fixed field predefined between the base station and the UE, and a non-fallback DCI format including a configurable field.

The DCI may be subjected to channel coding and modulation processes and then transmitted through a PDCCH. A cyclic redundancy check (CRC) is attached to the DCI message payload, and the CRC may be scrambled by a radio network temporary identifier (RNTI) corresponding to the identity of the UE. Different RNTIs may be used according to the purpose of the DCI message (for example, UE-specific data transmission, power control command, or random access response). That is, the RNTI may not be explicitly transmitted, but may be transmitted while being included in a CRC calculation process. Upon receiving a DCI message transmitted through the PDCCH, the UE may identify the CRC by using the allocated RNTI. If the CRC identification result is correct, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling the PUSCH, and the CRC may be scrambled by a C-RNTI. DCI format 0_0 in which the CRC is scrambled by a C-RNTI may include the following pieces of information in Table 4 below.

TABLE 4

| | |
|---|---|
| - | Identifier for DCI formats - [1] bit |
| - | Frequency domain resource assignment |
| | -[ ┌log₂( N_{RB}^{UL,BWP}(N_{RB}^{UL,BWP} + |

1)/2)┐ ] bits

| | |
|---|---|
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | Transmit power control (TPC) command for scheduled PUSCH- [2] bits |
| - | Uplink/supplementary uplink indicator (UL/SUL indicator) - 0 or 1 bit |

DCI format 0_1 may be used as non-fallback DCI for scheduling the PUSCH, and the CRC may be scrambled by a C-RNTI. DCI format 0_1 in which the CRC is scrambled by a C-RNTI may include the following pieces of information in Table 5 below.

```
TABLE 5
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    For resource allocation type 0, ┌N_{RB}^{UL,BWP}/P┐ bits
    For resource allocation type 1, ┌log₂(N_{RB}^{UL,BWP}(N_{RB}^{UL,BWP} + 1)/
    2)] bits
  Time domain resource assignment -1, 2, 3, or 4 bits
  virtual resource block-to-physical resource block (VRB-to-PRB)
mapping - 0 or 1 bit, only for resource allocation type 1.
    0 bit if only resource allocation type 0 is configured;
    1 bit otherwise.
  Frequency hopping flag - 0 or 1 bit, only for resource allocation type
  1.
    0 bit if only resource allocation type 0 is configured;
    1 bit otherwise.
  Modulation and coding scheme - 5 bits
  New data indicator - 1 bit
  Redundancy version - 2 bits
  HARQ process number - 4 bits
  1st downlink assignment index - 1 or 2 bits
    1 bit for semi-static HARQ-ACK codebook;
    2 bits for dynamic HARQ-ACK codebook with single HARQ-
    ACK codebook.
  2nd downlink assignment index - 0 or 2 bits
    2 bits for dynamic HARQ-ACK codebook with two HARQ-ACK
    sub-codebooks;
    0 bit otherwise.
  TPC command for scheduled PUSCH - 2 bits
  $\begin{matrix}S RS resource indicator - \\ ⌈ {log}_{2} ( {\sum }_{k = 1}^{{L}_{max} \sum } ( \begin{matrix}{N}_{S R S} \\ k\end{matrix} ) ) ⌉ or ⌈ {log}_{2} ( {N}_{SRS} ) ⌉ bits\end{matrix}$
    $⌈ {log}_{2} ( {\sum }_{k = 1}^{{L}_{max} \sum } ( \begin{matrix}{N}_{S R S} \\ k\end{matrix} ) ) ⌉ bits for non - codebook$
    based PUSCH transmission;
    ┌log₂(N_{SRS})┐ bits for codebook based PUSCH transmission.
  Precoding information and number of layers-up to 6 bits
  Antenna ports - up to 5 bits
  SRS request - 2 bits
  CSI request - 0, 1, 2, 3, 4, 5, or 6 bits
  Code block group (CBG) transmission information - 0, 2, 4, 6, or 8
  bits
  Phase tracking reference signal (PTRS)-demodulation reference
signal (DMRS) association- 0 or 2 bits.
  beta_offset indicator- 0 or 2 bits
  DMRS sequence initialization- 0 or 1 bit
```

DCI format 1_0 may be used as fallback DCI for scheduling the PDSCH, and the CRC may be scrambled by a C-RNTI. DCI format 1_0 in which the CRC is scrambled by a C-RNTI may include the following pieces of information in Table 6 below.

TABLE 6

| | |
|---|---|
| - | Identifier for DCI formats - [1] bit |
| - | Frequency domain resource assignment |
| | -[ ┌ log₂( N_{RB}^{DL,BWP}(N_{RB}^{DL,BWP} + |

1)/2)┐ ] bits

| | |
|---|---|
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | Physical uplink control channel (PUCCH) resource indicator- 3 bits |
| - | PDSCH-to-HARQ feedback timing indicator- [3] bits |

DCI format 1_1 may be used as non-fallback DCI for scheduling the PDSCH, and the CRC may be scrambled by a C-RNTI. DCI format 1_1 in which the CRC is scrambled by a C-RNTI may include the following pieces of information in Table 7 below.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |

| | |
|---|---|
| • | For resource allocation type 0, ┌N_{RB}^{DL,BWP}/P┐ bits |
| • | For resource allocation type 1, ┌log₂( N_{RB}^{DL,BWP}(N_{RB}^{DL,BWP} + 1)/ |

2)┐ bits

| | |
|---|---|
| - | Time domain resource assignment -1, 2, 3, or 4 bits |
| - | VRB-to-PRB mapping - 0 or 1 bit, only for resource allocation type 1. |

| | |
|---|---|
| • | 0 bit if only resource allocation type 0 is configured; |
| • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication- 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

PDCCH: CORESET, Resource Element Group (REG), Control Channel Element (CCE), and Search Space

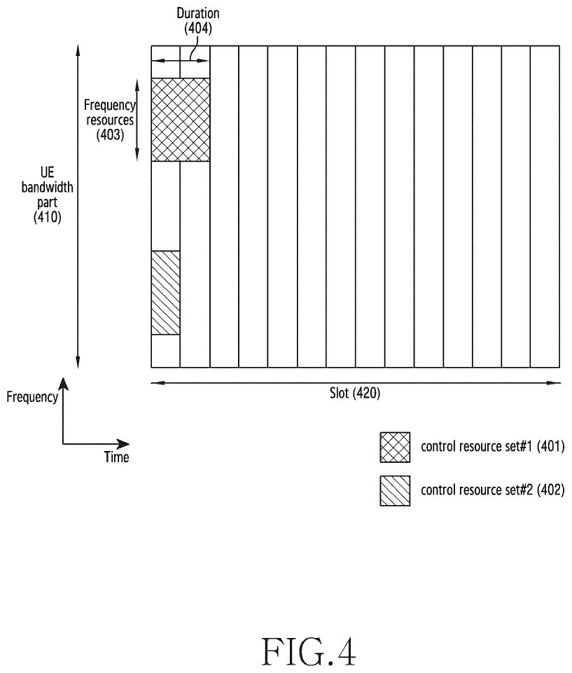

FIG. 4 illustrates an example of configuration of a CORESET used to transmit a DL control channel in a 5G wireless communication system according to an embodiment.

Referring to FIG. 4, a UE BWP 410 is configured along the frequency axis, and two control resource sets (control resource set #1 401 and control resource set #2 402) are configured within one slot 420 along the time axis. The control resource sets 401 and 402 may be configured in a specific frequency resource 403 within the entire UE BWP 410 along the frequency axis. One or multiple OFDM symbols may be configured along the time axis, and this may be defined as a control resource set duration 404. In FIG. 4, control resource set #1 401 is configured to have a control resource set duration corresponding to two symbols, and control resource set #2 402 is configured to have a control resource set duration corresponding to one symbol.

A control resource set in the 5G communication system described above may be configured for a UE by a base station through upper layer signaling (for example, system information, MIB or, RRC signaling). The description that a control resource set is configured for a UE may indicate that at least one piece of information among the identity, frequency location, and symbol duration of a control resource set is provided. For example, the control resource set may include the following pieces of information in Table 8 below.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(control resource set identity))

| | |
|---|---|
| frequencyDomainResources | BIT STRING (SIZE (45)), |

(frequency domain resource assignment information)

| | |
|---|---|
| duration | INTEGER |

```
      (1..maxCoReSetDuration),
    (time domain resource assignment information)
```

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED |

{sameAsREG-bundle, allContiguousRBs},

| | |
|---|---|
| interleaverSize | ENUMERATED {n2, n3, n6} |

```
        (interleaver size)
        shiftIndex
        INTEGER(0..maxNrofPhysicalResourceBlocks-1)
            OPTIONAL
          (interleaver shift)
          },
```

| | |
|---|---|
| nonInterleaved | NULL |

},

| | |
|---|---|
| tci-StatesPDCCH | SEQUENCE(SIZE |

```
      (1..maxNrofTCI-StatesPDCCH)) OF TCI-StateId
        OPTIONAL,
    (QCL configuration information)
```

| | |
|---|---|
| tci-PresentInDCI | ENUMERATED {enabled} |
| | OPTIONAL, -- Need S |

}

In Table 8, tci-StatesPDCCH (may be referred to as transmission configuration indication (TCI) state) configuration information may include information of one or multiple synchronization signal (SS)/physical broadcast channel (PBCH) block index or channel state information reference signal (CSI-RS) index, which is quasi-co-located with a DMRS transmitted in a corresponding control resource set.

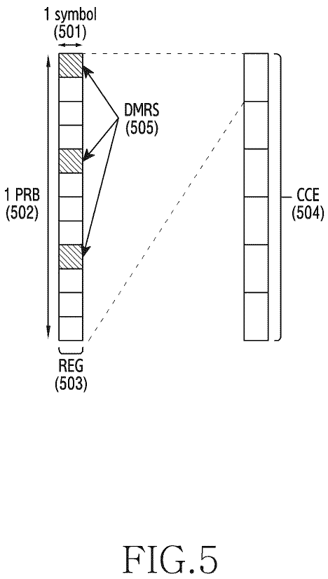

FIG. 5 illustrates a structure of a DL control channel in a wireless communication system according to an embodiment.

Referring to FIG. 5, a basic unit of time and frequency resources constituting a DL control channel available in a 5G communication system may be described. The basic unit of time and frequency resources constituting a control channel may be referred to as REG 503, and the REG 503 may be defined by one OFDM symbol 501 along the time axis and one PRB 502 (that is, 12 subcarriers) along the frequency axis. The base station may configure a DL control channel allocation unit by concatenating the REGs 503.

Provided that the basic unit of DL control channel allocation in 5G is a control channel element 504 as illustrated in FIG. 5, one control channel element (CCE) 504 may include multiple REGs 503. To describe the REG 503 illustrated in FIG. 5 the REG 503 may include 12 REs, and if one CCE 504 includes six REGs 503, one CCE 504 may then include 72 REs. A DL control resource set, once configured, may include multiple CCEs 504, and a specific DL control channel may be mapped to one or multiple CCEs 504 and then transmitted according to the aggregation level (AL) in the control resource set. The CCEs 504 in the control resource set are distinguished by numbers, and the numbers of CCEs 504 may be allocated according to a logical mapping scheme.

The basic unit of the DL control channel illustrated in FIG. 5, that is, the REG 503, may include both REs to which DCI is mapped, and an area to which a reference signal (DMRS 505) for decoding the same is mapped. Three DRMSs 503 may be transmitted inside one REG 505. The number of CCEs necessary to transmit a PDCCH may be 1, 2, 4, 8, or 16 according to the AL, and different number of CCEs may be used to implement link adaption of the DL control channel. For example, in the case of AL=L, one DL control channel may be transmitted through L CCEs. The UE needs to detect a signal while having no information regarding the DL control channel, and a search space indicating a set of CCEs has thus been defined for blind decoding. The search space is a set of DL control channel candidates including CCEs which the UE needs to attempt to decode at a given AL. Since 1, 2, 4, 8, or 16 CCEs constitute a bundle at various ALs, the UE may have multiple search spaces. A search space set may be defined as a set of search spaces at all configured ALs.

The search spaces may be classified into common search spaces and UE-specific search spaces. A group of UEs or all UEs may search a common search space of the PDCCH to receive cell-common control information such as a paging message or dynamic scheduling regarding system information. For example, PDSCH scheduling allocation information for transmitting an SIB including a cell operator information or the like may be received by searching the common search space of the PDCCH. In the case of a common search space, a group of UEs or all UEs need to receive the PDCCH, and the same may thus be defined as a pre-promised set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In the 5G communication system, search space parameters for a PDCCH may be configured for the UE by the base station through upper layer signaling (for example, at least one of SIB, MIB, or RRC signaling). For example, the base station may configure, for the UE with, at least one of the number of PDCCH candidates at each aggregation level (AL) L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, and a control resource set index for monitoring the search space. For example, the at least one piece of information configured for the UE may include at least one of the following pieces of information in Table 9 below.

TABLE 9

| | |
|---|---|
| SearchSpace ::= | SEQUENCE { |

```
  -- Identity of the search space. SearchSpaceId = 0 identifies the SearchSpace
      configured via PBCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityAndOffset | CHOICE { |

(monitoring slot level cycle)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration(monitoring duration) | INTEGER (2..2559) |
| monitoringSymbolsWithinSlot | BIT STRING (SIZE (14)) |
| | OPTIONAL, |

(monitoirng symbols within slot)

| | |
|---|---|
| nrofCandidates | SEQUENCE { |

(number of PDCCH candidates per AL)

| | |
|---|---|
| aggregationLevel1 | ENUMERATED {n0, n1, n2, n3, |

n4, n5, n6, n8},

| | |
|---|---|
| aggregationLevel2 | ENUMERATED {n0, n1, n2, n3, |

n4, n5, n6, n8},

| | |
|---|---|
| aggregationLevel4 | ENUMERATED {n0, n1, n2, n3, |

n4, n5, n6, n8},

| | |
|---|---|
| aggregationLevel8 | ENUMERATED {n0, n1, n2, n3, |

n4, n5, n6, n8},

| | |
|---|---|
| aggregationLevel16 | ENUMERATED {n0, n1, n2, n3, |

```
      n4, n5, n6, n8}
  },
```

| | |
|---|---|
| searchSpaceType | CHOICE { |

```
  (search space type)
      -- Configures this search space as common search space (CSS) and DCI
      formats to monitor.
```

| | |
|---|---|
| common | SEQUENCE { |

```
    (common search space)
          }
```

| | |
|---|---|
| ue-Specific | SEQUENCE { |

```
    (UE-specific search space)
        -- Indicates whether the UE monitors in this UE-specific search space
      (USS) for DCI formats 0-0 and 1-0 or for formats 0-1 and 1-1.
```

| | |
|---|---|
| formats | ENUMERATED { formats0-0- |

```
      And-1-0, formats0-1-And-1-1},
        ...
      }
```

According to configuration information, the base station may configure one or multiple search space sets for the UE. The base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_01 with CRC scrambled by INT-RNTI
DCI format 2_2 with CRC scrambled by TPC-PUSCH-RNTI, TPC-PUCCH-RNTI
DCI format 2_03 with CRC scrambled by TPC-SRS-RNTI

Combinations of DCI formats and RNTIs given below may be monitored in a UE-specific search space.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below.
Cell RNTI(C-RNTI) for scheduling of UE-specific PDSCH
Temporary cell RNTI(TC-RNTI) for scheduling of UE-specific PDSCH
Configured scheduling RNTI (CS-RNTI): used to schedule a semi-statically configured UE-specific PDSCH
Random access RNTI (RA-RNTI) for scheduling of PDSCH in random access stage
Paging RNTI (P-RNTI) for scheduling of PDSCH in which paging is transmitted
System information RNTI (SI-RNTI) for scheduling of PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In the 5G communication system, the search space at AL L in connection with control resource set p and search space set s may be expressed by Equation (1) below.

$$L \cdot \{ ( {y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad ( 1 )$$

L: AL
   n_{CI}: carrier index
   N_{CCE,p}: total number of CCEs existing in control resource set p
n_{s,f}^{μ}: slot index
M_{s,max}^{(L)}: number of PDCCH candidates at AL L
m_{s,n}_{_{CI}}=0, . . . M_{s,max}^{(L)}−1: PDCCH candidate index at AL L
i=0, . . . , L−1
Y_{p,n}_{_{s,f}}_{^{μ}}=(Aₚ·Y_{p,n}_{_{s,f}}_{^{μ}}₋₁)mod D, Y_{p,-1}=n_{RNTI}≠0, Aₚ=39827 for pmod 3=0, Aₚ=39829 for pmod 3=1, Aₚ=39839 for pmod 3=2, D=65537
n_{RNTI}: UE identity

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In the 5G communication system, multiple search space sets may be configured by different parameters as provided in Table 9 above, and the group of search space sets monitored by the UE at each timepoint may differ. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### Rate Matching/Puncturing

If time and frequency resource A to transmit symbol sequence A overlaps time and frequency resource B, a rate matching or puncturing operation may be considered as an operation of transmitting/receiving channel Ain consideration of resource C (region in which resource A and resource B overlap).

### Rate Matching Operation

The base station may transmit channel A after mapping the same only to remaining resource domains other than resource C (region overlapping resource B) among the entire resource A which is to be used to transmit symbol sequence A to the UE. For example, assuming that symbol sequence A is configured as {symbol #1, symbol #2, symbol #3, symbol4}, resource A is {resource #1, resource #2, resource #3, resource #4}, and resource B is {resource #3, resource #5}, the base station may transmit symbol sequence A after successively mapping the same to remaining resources {resource #1, resource #2, resource #4} other than {resource #3} (corresponding to resource C) among resource A. Consequently, the base station may transmit symbol sequence {symbol #1, symbol #2, symbol #3} after mapping the same to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence Abased on an assumption that symbol sequence A has been mapped and transmitted in the remaining area other than resource C among the entire resource A. For example, if symbol sequence A is configured as {symbol #1, symbol #2, symbol #3, symbol4}, if resource A is {resource #1, resource #2, resource #3, resource #4}, and if resource B is {resource #3, resource #5}, the UE may receive symbol sequence A based on an assumption that symbol sequence A has been successively mapped to remaining resources {resource #1, resource #2, resource #4} other than {resource #3} (corresponding to resource C) among resource A. Consequently, the UE may perform a series of following receiving operations based on an assumption that symbol sequence {symbol #1, symbol #2, symbol #3} has been transmitted after being mapped to {resource #1, resource #2, resource #4}, respectively.

### Puncturing Operation

If there is resource C (region overlapping resource B) among the entire resource A which is to be used to transmit symbol sequence A to the UE, the base station may map symbol sequence A to the entire resource A, but may not perform transmission in the resource area corresponding to resource C, and may perform transmission with regard to only the remaining resource area other than resource C among resource A. For example, assuming that symbol sequence A is configured as {symbol #1, symbol #2, symbol #3, symbol4}, resource A is {resource #1, resource #2, resource #3, resource #4}, and resource B is {resource #3, resource #5}, the base station may map symbol sequence {symbol #1, symbol #2, symbol #3, symbol #4} to resource A {resource #1, resource #2, resource #3, resource #4}, respectively, may transmit only symbol sequence {symbol #1, symbol #2, symbol #4} corresponding to remaining resources {resource #1, resource #2, resource #4} other than {resource #3} (corresponding to resource C) among resource A, and may not transmit {symbol #3}mapped to {resource #3} (corresponding to resource C). Consequently, the base station may transmit symbol sequence {symbol #1, symbol #2, symbol #4} after mapping this symbol sequence to {resource #1, resource #2, resource #4}, respectively.

The UE may assess resource A and resource B from scheduling information regarding symbol sequence A from the base station, thereby assessing resource C (region in which resource A and resource B overlap). The UE may receive symbol sequence Abased on an assumption that symbol sequence A has been mapped to the entire resource Abut transmitted only in the remaining area other than resource C among the resource area A. For example, if symbol sequence A is configured as {symbol #1, symbol #2, symbol #3, symbol4}, if resource A is {resource #1, resource #2, resource #3, resource #4}. If resource B is {resource #3, resource #5}, the UE may assume that symbol sequence A {symbol #1, symbol #2, symbol #3, symbol4} is mapped to resource A {resource #1, resource #2, resource #3, resource #4}, respectively, but {symbol #3} mapped to {resource #3} (corresponding to resource C) is not transmitted. Based on the assumption that symbol sequence {symbol #1, symbol #2, symbol #4} corresponding to remaining resources {resource #1, resource #2, resource #4} other than {resource #3} (corresponding to resource C) among resource A has been mapped and transmitted, the UE may receive this symbol sequence {symbol #1, symbol #2, symbol #4}. Consequently, the UE may perform a series of following receiving operations based on an assumption that symbol sequence {symbol #1, symbol #2, symbol #4} has been transmitted after being mapped to {resource #1, resource #2, resource #4}, respectively.

Rate matching refers to adjusting the size of a signal in consideration of the amount of resources that can be used to transmit the signal. For example, data channel rate matching may indicate that a data channel is not mapped and transmitted with regard to specific time and frequency resource domains, and the size of data is adjusted accordingly.

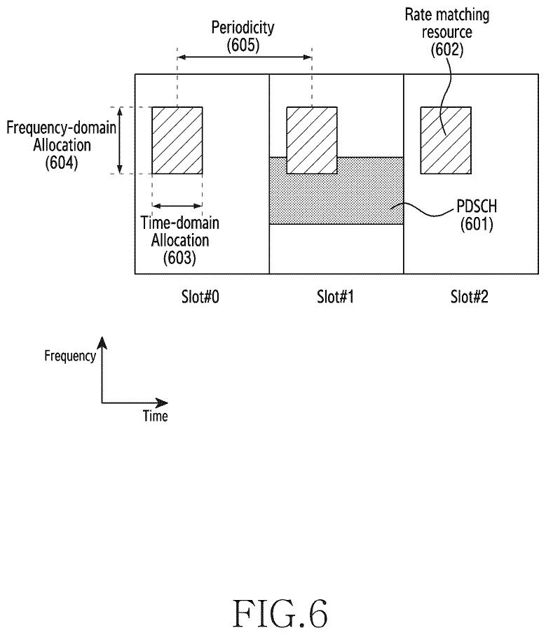

FIG. 6 illustrates a method in which a base station and a UE transmit/receive data in consideration of a PDSCH and a rate matching resource according to an embodiment.

Referring to FIG. 6, a PDSCH 601 and a rate matching resource 602 are shown. The base station may configure one or multiple rate matching resources 602 for the UE through RRC signaling. Rate matching resource 602 configuration information may include time-domain resource allocation information 603, frequency-domain resource allocation information 604, and periodicity information 605. In the following, a bitmap corresponding to the frequency-domain resource allocation information 604 will be referred to as a first bitmap, a bitmap corresponding to the time-domain resource allocation information 603 will be referred to as a second bitmap, and a bitmap corresponding to the periodicity information 605 will be referred to as a third bitmap. If all or some of time and frequency resources of the scheduled PDSCH 601 overlap a configured rate matching resource 602, the base station may rate-match and transmit the PDSCH 601 in a rate matching resource 602 part, and the UE may perform reception and decoding after assuming that the PDSCH 601 has been rate-matched in a rate matching resource 602 part.

The base station may dynamically notify the UE, through DCI, of whether the PDSCH will be rate-matched in the configured rate matching resource part through an additional configuration, corresponding to the above-described rate matching indicator inside the DCI format. Specifically, the base station may select some from the configured rate matching resources and group them into a rate matching resource group, and may indicate, to the UE, whether the PDSCH is rate-matched with regard to each rate matching resource group through DCI by using a bitmap type. For example, if four rate matching resources RMR #1, RMR #2, RMR #3, and RMR #4 are configured, the base station may configure a rate matching groups RMG #1={RMR #1, RMR #2}, RMG #2={RMR #3, RMR #4}, and may indicate, to the UE, whether rate matching occurs in RMG #1 and RMG #2, respectively, through a bitmap by using two bits inside the DCI field. For example, “1” may indicate that rate matching is to be conducted, and “0” may indicate that rate matching is not to be conducted.

The 5G communication system may support granularity of an RB symbol level and RE level as a method for configuring the above-described rate matching resources for a UE. More specifically, the following configuration method may be followed.

### RB Symbol Level

The UE may have a maximum of four RateMatchPatterns configured per each BWP through upper layer signaling, and one RateMatchPattern may include, in connection with a reserved resource inside a BWP, a resource having time and frequency resource domains of the corresponding reserved resource configured as a combination of an RB-level bitmap and a symbol-level bitmap in the frequency domain. The reserved resource may span one or two slots. A time domain pattern (periodicityAndPattern) may be additionally configured wherein time and frequency domains including respective RB-level and symbol-level bitmap pairs are repeated.

One RateMatchPattern may also include a resource region corresponding to a time domain pattern configured by time and frequency domain resource regions configured by a control resource set inside a BWP and a search space configuration in which corresponding resource regions are repeated.

### RE Level

The UE may have the following contents configured through upper layer signaling.

configuration information (lte-CRS-ToMatchAround) regarding a RE corresponding to a cell-specific reference signal (CRS) or common reference signal pattern, which may include at least one of LTE CRS's port number (nrofCRS-Ports) and LTE-CRS-vshift(s) value (v-shift), location information (carrierFreqDL) of a center subcarrier of a LTE carrier from a reference frequency point (for example, reference point A), the LTE carrier's bandwidth size (carrierBandwidthDL) information, and subframe configuration information (mbsfn-SubframConfigList) corresponding to a multicast-broadcast single-frequency network (MBSFN). The UE may determine the position of the CRS inside the NR slot corresponding to the LTE subframe, based on the above-mentioned pieces of information.

The RE level may include configuration information regarding a resource set corresponding to one or multiple zero power (ZP) CSI-RSs inside a BWP.

### PDSCH/PUSCH: Relating to Frequency Resource Allocation

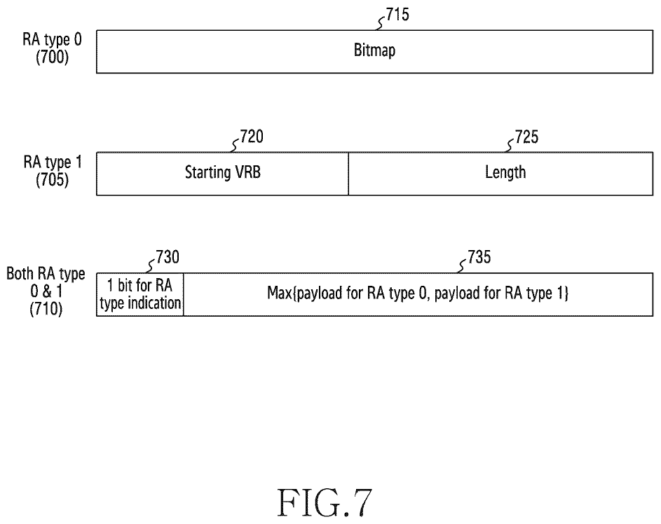

FIG. 7 illustrates an example of frequency domain resource assignment of a PDSCH or a PUSCH in a wireless communication system according to an embodiment.

FIG. 7 illustrates three frequency domain resource assignment methods of type-0 700, type-1 705, and a dynamic switch 710 which are configurable via a higher layer in the NR wireless communication system.

Referring to FIG. 7, if a terminal is configured 700, via higher-layer signaling, to use only type-0 resource allocation, some DCI for assigning a PDSCH/PUSCH to the terminal configured to use only type-0 resource allocation may include a bitmap including N_{RBG} (number of RBG) bits. In this case, N_{RBG} refers to the number of resource block groups (RBGs) determined as shown in Table 11 below according to a BWP size assigned by a BWP indicator and higher-layer parameter rbg-size, and data may be transmitted on an RBG that is indicated to be 1 by a bit map.

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

A size of a BWP may be the number of RBs included in the BWP. More specifically, when type-0 resource allocation is indicated, a length of a frequency domain resource assignment (FDRA) field of DCI received by the terminal may be equal to the number (N_{RBG}) of RBGs, and N_{RBG} ┌(N_{BWP}^{size}+(N_{BWP}^{start} mod P))/P┘. A first RBG may include RBG₀^{size}=P−N_{BWP}^{size} mod P RBs, and if (N_{BWP}^{start}+N_{BWP}^{size})mod P>0 a last RBG may include RBGₗₐₛₜ^{size}=(N_{BWP}^{start}+N_{BWP}^{size})mod P RBs, otherwise, the last RBG may include RBGₗₐₛₜ^{size}=P RBs. The remaining RBGs may include P RBs. P is the number of nominal RBGs determined according to Table 11 above.

If the terminal is configured 705, via higher-layer signaling, to use only type-1 resource allocation, DCI for assigning a PDSCH/PUSCH to the terminal configured to use only type-1 resource allocation may include frequency domain resource assignment (FDRA) information including [log₂(N_{RB}^{BWP}*(N_{RB}^{BWP}+1)/2] bits. N_{RB}^{BWP} may be the number of RBs included in a BWP. Based on the methods described above, a base station may configure a starting VRB 720 and a length 725 of a frequency domain resource consecutively allocated from the starting VRB.

If the terminal is configured 710, via higher-layer signaling, to use both type-0 resource allocation and type-1 resource allocation, some DCI for assigning a PDSCH/PUSCH to the terminal configured to use both type-0 resource allocation and type-1 resource allocation may include frequency domain resource assignment information including bits of a large value 735 among a payload 715 (or bitmap) for configuration of type-0 resource allocation and payloads 720 and 725 for configuration of type-1 resource allocation. In this case, one bit may be added to a most significant bit (MSB) of the frequency domain resource assignment information in the DCI, and if the corresponding bit has a value of “0, use of type-0 resource allocation may be indicated, and if the bit has a value of “1”, use of type-1 resource allocation may be indicated.

### PDSCH/PUSCH: Relating to Time Resource Allocation

The base station may configure, for the terminal via higher-layer signaling (e.g., RRC signaling), a table for time domain resource assignment information on a PDSCH and a PUSCH. A table including up to maxNrofDL-Allocations=16 entries may be configured for a PDSCH, and a table including up to maxNrofUL-Allocations=16 entries may be configured for a PUSCH. the time domain resource assignment information may include at least one of PDCCH-to-PDSCH slot timing (denoted as K0, and corresponding to a time interval in units of slots between a time point at which a PDCCH is received and a time point at which a PDSCH scheduled by the received PDCCH is transmitted), PDCCH-to-PUSCH slot timing (denoted as K2, and corresponding to a time interval in units of slots between a time point at which a PDCCH is received and a time point at which a PUSCH scheduled by the received PDCCH is transmitted), information on a position and a length of a start symbol, in which the PDSCH or PUSCH is scheduled, within a slot, and a mapping type of the PDSCH or PUSCH. For example, at least one piece of information included in Table 12 below or Table 13 below may be transmitted from the base station to the terminal.

TABLE 12
PDSCH-TimeDomainResourceAllocationList information element

| | |
|---|---|
| PDSCH-TimeDomainResourceAllocationList ::= | SEQUENCE (SIZE(1..maxNrofDL- |

Allocations)) OF PDSCH-TimeDomainResourceAllocation

| | |
|---|---|
| PDSCH-TimeDomainResourceAllocation ::= | SEQUENCE { |
| k0 | INTEGER(0..32) |

OPTIONAL, -- Need S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER (0..127) |

(PDSCH start symbol and length)
}

TABLE 13
PUSCH-TimeDomainResourceAllocation information element

| | |
|---|---|
| PUSCH-TimeDomainResourceAllocationList ::= | SEQUENCE (SIZE(1..maxNrofUL- |

Allocations)) OF PUSCH-TimeDomainResourceAllocation

| | |
|---|---|
| PUSCH-TimeDomainResourceAllocation ::= | SEQUENCE { |
| k2 | INTEGER(0..32) |

OPTIONAL, -- Need S
(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(PUSCH start symbol and length)
}

The base station may provide a notification of one of the entries in the tables for the time domain resource assignment information described above to the terminal via L1 signaling (e.g., DCI) (e.g., the entry may be indicated by a “time domain resource allocation” field in the DCI). The terminal may acquire the time domain resource allocation information for the PDSCH or PUSCH, based on the DCI received from the base station.

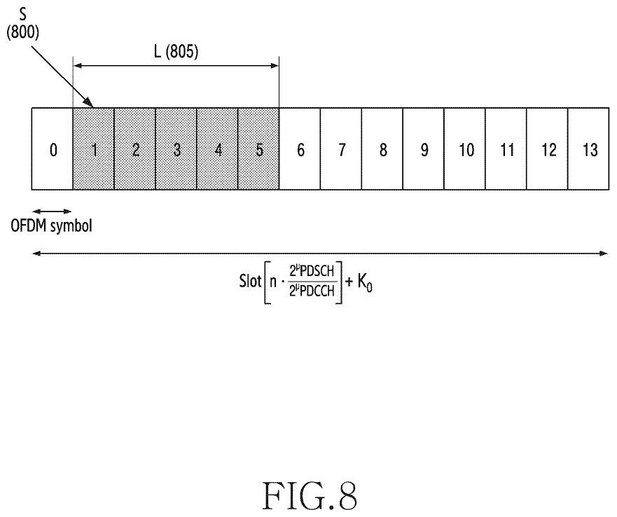

FIG. 8 illustrates an example of time domain resource allocation with regard to a PDSCH in a wireless communication system according to an embodiment.

Referring to FIG. 8, the base station may indicate, to the UE, the time domain location of a PDSCH resource according to the subcarrier spacing (SCS) (MpdSCh, MpdCCH) of a data channel and a control channel configured by using an upper layer, the scheduling offset (K0) value, and the start location 800 and length 805 of an OFDM symbol inside one slot dynamically indicated through DCI.

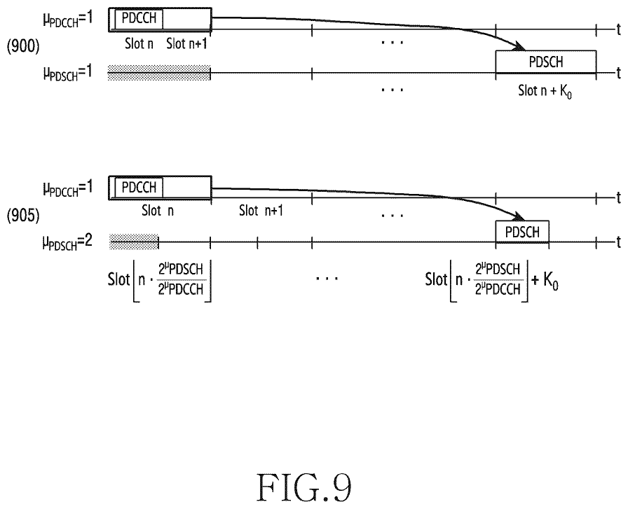

FIG. 9 illustrates an example of time domain resource allocation according to a subcarrier spacing with regard to a data channel and a control channel in a wireless communication system according to an embodiment.

Referring to FIG. 9, if the data channel and the control channel have the same subcarrier spacing 900 (μPDSCH=μPDCCH), the slot number for data and that for control are identical, and the base station and the UE may accordingly generate a scheduling offset in conformity with a predetermined slot offset K0. However, if the data channel and the control channel have different subcarrier spacings 905 (PDSCH≠PDCCH), the slot number for data and that for control are different, and the base station and the UE may accordingly generate a scheduling offset in conformity with a predetermined slot offset K0 with reference to the subcarrier spacing of the PDCCH.

### PUSCH: Regarding Transmission Scheme

PUSCH transmission may be dynamically scheduled by a UL grant inside DCI, or operated by means of configured grant Type 1 or Type 2. Dynamic scheduling indication regarding PUSCH transmission can be made by DCI format 0_0 or 0_1.

Configured grant Type 1 PUSCH transmission may be configured semi-statically by receiving configuredGrantConfig including rrc-ConfiguredUplinkGrant in Table 14 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 14 below through upper signaling. If PUSCH transmission is operated by a configured grant, parameters applied to the PUSCH transmission are applied through configuredGrantConfig (higher layer signaling) in Table 14 except for dataScramblingIdentityPUSCH, txConfig, codebookSubset, maxRank, and scaling of UCI-OnPUSCH, which are provided by pusch-Config (higher layer signaling) in Table 15 below. If provided with transformPrecoder inside configuredGrantConfig (higher layer signaling) in Table 14 below, the UE applies tp-pi2BPSK inside pusch-Config in Table 15 below to PUSCH transmission operated by a configured grant.

TABLE 14

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, |
| qam64LowSE} | OPTIONAL, -- |

Need S

| | |
|---|---|
| mcs-TableTransformPrecoder | ENUMERATED {qam256, |
| qam64LowSE} | OPTIONAL, -- |

Need S

| | |
|---|---|
| uci-OnPUSCH | SetupRelease { CG-UCI- |
| OnPUSCH } | OPTIONAL, -- |

Need M

| | |
|---|---|
| resourceAllocation | ENUMERATED |

{ resourceAllocationType0, resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, |
| s3-0000} | OPTIONAL, -- Need R |
| periodicity | ENUMERATED { |
| | sym2, sym7, sym1x14, |

sym2x14, sym4x14, sym5x14, sym8x14, sym10x14, sym16x14, sym20x14,

sym32x14, sym40x14,

sym64x14, sym80x14, sym128x14, sym160x14, sym256x14, sym320x14, sym512x14,

sym640x14, sym1024x14,

sym1280x14, sym2560x14, sym5120x14,

sym6, sym1x12, sym2x12,

sym4x12, sym5x12, sym8x12, sym10x12, sym16x12, sym20x12, sym32x12,

sym40x12, sym64x12,

sym80x12, sym128x12, sym 160x12, sym256x12, sym320x12, sym512x12,
sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER |

```
(0..maxNrofPUSCH-PathlossReferenceRSs-1),
    ...
  }
OPTIONAL, -- Need R
    ...
}
```

The DMRS antenna port for PUSCH transmission is identical to an antenna port for SRS transmission. PUSCH transmission may follow a codebook-based transmission method and a non-codebook-based transmission method according to whether the value of txConfig inside pusch-Config (higher layer signaling) in Table 15 is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE may perform beam configuration for PUSCH transmission by using pucch-spatialRelationInfoID corresponding to a UE-specific PUCCH resource corresponding to the minimum ID inside an activated UL BWP inside a serving cell, and the PUSCH transmission may be based on a single antenna port. The UE may not expect scheduling regarding PUSCH transmission through DCI format 0_0 inside a BWP having no configured PUCCH resource including pucch-spatialRelationInfo. If the UE has no configured txConfig inside pusch-Config in Table 15 below, the UE may not expect scheduling through DCI format 0_1.

TABLE 15

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, |
| nonCodebook} | OPTIONAL, -- Need S |
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, |
| interSlot} | OPTIONAL, -- Need S |
| frequencyHoppingOffsetLists | SEQUENCE (SIZE (1..4)) OF |

INTEGER (1.. maxNrofPhysicalResourceBlocks-1)
OPTIONAL, -- Need M

| | |
|---|---|
| resourceAllocation | ENUMERATED |

{ resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, |
| qam64LowSE} | OPTIONAL, -- Need |

S

| | |
|---|---|
| mcs-TableTransformPrecoder | ENUMERATED {qam256, |
| qam64LowSE} | OPTIONAL, -- Need |

S

| | |
|---|---|
| transformPrecoder | ENUMERATED {enabled, |
| disabled} | OPTIONAL, -- Need S |
| codebookSubset | ENUMERATED |

{fullyAndPartialAndNonCoherent, partialAndNonCoherent, nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI- |
| OnPUSCH} | OPTIONAL, -- Need M |
| tp-pi2BPSK | ENUMERATED {enabled} |

OPTIONAL, -- Need S
...
}

The codebook-based PUSCH transmission may be dynamically scheduled through DCI format 0_0 or 01, and may be operated semi-statically configured by a configured grant. If a codebook-based PUSCH is dynamically scheduled through DCI format 0_1 or configured semi-statically by a configured grant, the UE may determine a precoder for PUSCH transmission, based on an SRS resource indicator (SRI), a transmission precoding matrix indicator (TPMI), and a transmission rank (the number of PUSCH transmission layers).

The SRI may be given through the SRS resource indicator field inside the DCI or configured through srs-ResourceIndicator (higher layer signaling). During codebook-based PUSCH transmission, the UE may have at least one SRS resource configured therefor, and may have a maximum of two SRS resources configured therefor. If the UE is provided with an SRI through DCI, the SRS resource indicated by the SRI may refer to the SRS resource corresponding to the SRI among SRS resources transmitted prior to the PDCCH including the SRI. The TPMI and the transmission rank may be given through a “precoding information and number of layers” field inside the DCI or through precodingAndNumberOfLayers (higher layer signaling). The TPMI may be used to indicate a precoder applied to PUSCH transmission. If one SRS resource is configured for the UE, the TPMI may be used to indicate a precoder to be applied in the configured SRS resource. If multiple SRS resources are configured for the UE, the TPMI may be used to indicate a precoder to be applied in an SRS resource indicated through the SRI.

The precoder to be used for PUSCH transmission may be selected from an UL codebook having the same number of antenna ports as the value of nrofSRS-Ports inside SRS-Config (higher layer signaling). In connection with codebook-based PUSCH transmission, the UE may determine a codebook subset, based on codebookSubset inside pusch-Config (higher layer signaling) and TPMI. The codebookSubset inside pusch-Config (higher layer signaling) may be configured to be one of “fullyAndPartialAndNonCoherent”, “partialAndNonCoherent”, or “noncoherent”, based on UE capability reported by the UE to the base station. If the UE reported “partialAndNonCoherent’” as UE capability, the UE may not expect that the value of codebookSubset (higher layer signaling) will be configured as “fullyAndPartialAndNonCoherent”. In addition, if the UE reported “nonCoherent” as UE capability, UE may not expect that the value of codebookSubset (higher layer signaling) will be configured as “fullyAndPartialAndNonCoherent” or “partialAndNonCoherent”. If nrofSRS-Ports inside SRS-ResourceSet (higher layer signaling) indicates two SRS antenna ports, UE may not expect that the value of codebookSubset (higher layer signaling) will be configured as “partialAndNonCoherent”.

The UE may have one SRS resource set configured therefor, wherein the value of usage inside SRS-ResourceSet (higher layer signaling) is “codebook”, and one SRS resource may be indicated through an SRI inside the SRS resource set. If multiple SRS resources are configured inside the SRS resource set wherein the value of usage inside SRS-ResourceSet (higher layer signaling) is “codebook”, the UE may expect that the value of nrofSRS-Ports inside SRS-Resource (higher layer signaling) is identical with regard to all SRS resources.

The UE may transmit, to the base station, one or multiple SRS resources included in the SRS resource set wherein the value of usage is configured as “codebook” according to upper signaling, and the base station may select one from the SRS resources transmitted by the UE and indicate the UE to be able to transmit a PUSCH by using transmission beam information of the corresponding SRS resource. In connection with the codebook-based PUSCH transmission, the SRI may be used as information for selecting the index of one SRS resource, and may be included in DCI. Additionally, the base station may add information indicating the rank and TPMI to be used by the UE for PUSCH transmission to the DCI. Using the SRS resource indicated by the SRI, the UE may apply the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 01, and may be operated semi-statically by a configured grant. If at least one SRS resource is configured inside an SRS resource set wherein the value of usage inside SRS-ResourceSet (higher layer signaling) is “nonCodebook”, non-codebook-based PUSCH transmission may be scheduled for the UE through DCI format 0_1.

With regard to the SRS resource set wherein the value of usage inside SRS-ResourceSet (higher layer signaling) is “nonCodebook”, one connected non-zero power (NZP) CSI-RS may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE may not expect that information regarding the precoder for SRS transmission will be updated.

If the configured value of resourceType inside SRS-ResourceSet (higher layer signaling) is aperiodic, the connected NZP CSI-RS may be indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI should not indicate cross carrier or cross BWP scheduling. If the value of SRS request indicates the existence of a NZP CSI-RS, the NZP CSI-RS may be positioned in the slot used to transmit the PDCCH including the SRS request field. In this case, TCI states configured for the scheduled subcarrier may not be configured as QCL-TypeD.

If there is a periodic or semi-persistent SRS resource set configured, the connected NZP CSI-RS may be indicated through associatedCSI-RS inside SRS-ResourceSet (higher layer signaling). With regard to non-codebook-based transmission, the UE may not expect that spatialRelationInfo which is upper signaling regarding the SRS resource and associatedCSI-RS inside SRS-ResourceSet (higher layer signaling) will be configured together.

If multiple SRS resources are configured for the UE, the UE may determine a precoder to be applied to PUSCH transmission and the transmission rank, based on an SRI indicated by the base station. The SRI may be indicated through the SRS resource indicator field inside the DCI or configured through srs-ResourceIndicator (higher layer signaling). Similarly to the above-described codebook-based PUSCH transmission, if the UE is provided with the SRI through DCI, the SRS resource indicated by the corresponding SRI may refer to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE may occupy the same RB. The UE may configure one SRS port for each SRS resource. There may be only one configured SRS resource set wherein the value of usage inside SRS-ResourceSet (higher layer signaling) is configured as “nonCodebook”, and there may be a maximum of four configured SRS resources for non-codebook-based PUSCH transmission.

The base station may transmit one NZP-CSI-RS connected to the SRS resource set to the UE, and the UE may calculate the precoder to be used when transmitting one or multiple SRS resources inside the corresponding SRS resource set, based on the result of measurement when the corresponding NZP-CSI-RS is received. The UE may apply the calculated precoder when transmitting, to the base station, one or multiple SRS resources inside the SRS resource set wherein the configured usage is “nonCodebook”. The base station may select one or multiple SRS resources from the received one or multiple SRS resources. In connection with the non-codebook-based PUSCH transmission, the SRI may indicate an index that may express one SRS resource or a combination of multiple SRS resources, and the SRI is included in DCI. The number of SRS resources indicated by the SRI transmitted by the base station may be the number of transmission layers of the PUSCH, and the UE may transmit the PUSCH by applying the precoder applied to SRS resource transmission to each layer.

Carrier aggregation (CA)/Dual connectivity (DC)

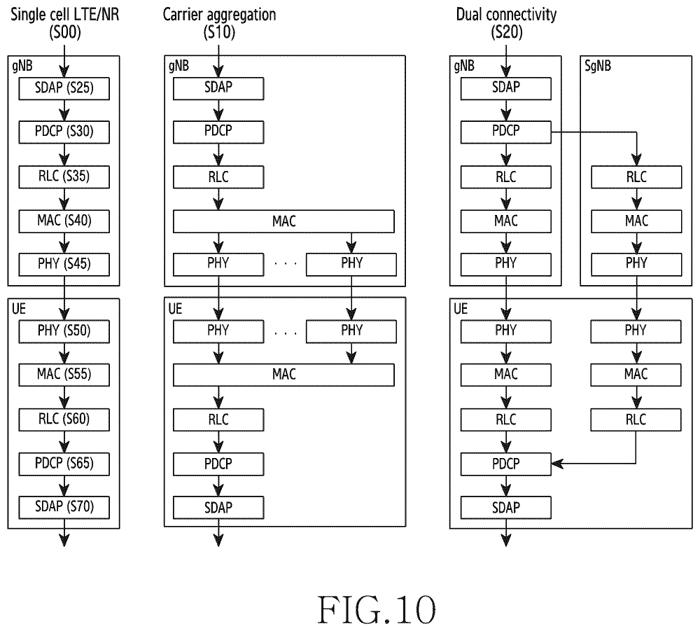

FIG. 10 illustrates radio protocol structures of a base station and a UE in single cell, carrier aggregation, and dual connectivity situations according to an embodiment.

Referring to FIG. 10, a radio protocol of a next-generation mobile communication system includes NR service data adaptation protocols (SDAPs) S25 and S70, NR PDCPs S30 and S65, NR radio link controls (RLCs) S35 and S60, and NR MACs S40 and S55, in a UE and an NR base station, respectively.

The main functions of the NR SDAPs S25 and S70 may include at least one of the following functions.

### Transfer of User Plane Data

Mapping between a quality of service (QoS) flow and a data radio bearer (DRB) for both DL and UL

### Marking QoS Flow ID in Both DL and UL Packets

### Reflective QoS Flow to DRB Mapping for the UL SDAP Protocol Data Units (PDUs)

With respect to the SDAP layer device, whether to use a header of the SDAP layer device or whether to use a function of the SDAP layer device for each PDCP layer device, each bearer, or each logical channel may be configured for the UE through an RRC message. If an SDAP header is configured, the NAS QoS reflection configuration 1-bit indicator (NAS reflective QoS) of the SDAP header and the AS QoS reflection configuration 1-bit indicator (AS reflective QoS) thereof may be indicated by the base station, so that the UE can update or reconfigure mapping information regarding the QoS flow and data bearer of the UL and DL. The SDAP header may include QoS flow ID information indicating the QoS. The QoS information may be used as data processing priority or scheduling information for smoothly supporting services.

The main functions of the NR PDCPs S30 and S65 may include at least one of the following functions.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in UL

The above-mentioned reordering function of the NR PDCP device may refer to a function of reordering PDCP PDUs received from a lower layer in an order based on the PDCP sequence number (SN), and may include a function of transferring data to an upper layer in the reordered sequence. Alternatively, the reordering function of the NR PDCP device may include a function of instantly transferring data without considering the order, recording PDCP PDUs lost as a result of reordering, reporting the state of the lost PDCP PDUs to the transmitting side, and requesting retransmission of the lost PDCP PDUs.

The main functions of the NR RLCs S35 and S60 may include at least one of the following functions.
Transfer of upper layer PDUs
In-sequence delivery of upper layer PDUs
Out-of-sequence delivery of upper layer PDUs
Error Correction through automatic repeat request (ARQ)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device may refer to a function of successively delivering RLC SDUs received from the lower layer to the upper layer. The in-sequence delivery of the NR RLC device may include a function of reassembling and delivering multiple RLC SDUs received, into which one original RLC SDU has been segmented, may include a function of reordering the received RLC PDUs with reference to the RLC sequence number (SN) or PDCP sequence number (SN), may include a function of recording RLC PDUs lost as a result of reordering, may include a function of reporting the state of the lost RLC PDUs to the transmitting side, and may include a function of requesting retransmission of the lost RLC PDUs.

The in-sequence delivery of the NR RLC device may include, if there is a lost RLC SDU, successively delivering only RLC SDUs before the lost RLC SDU to the upper layer, and may include, if a predetermined timer has expired although there is a lost RLC SDU, successively delivering all RLC SDUs received before the timer was started to the upper layer. Alternatively, the in-sequence delivery of the NR RLC device may include, if a predetermined timer has expired although there is a lost RLC SDU, successively delivering all currently received RLC SDUs to the upper layer. The RLC PDUs may be processed in the received order (regardless of the sequence number order, in the order of arrival) and delivered to the PDCP device regardless of the order (out-of-sequence delivery). Segments which are stored in a buffer, or which are to be received later, may be received, reconfigured into one complete RLC PDU, processed, and delivered to the PDCP device. The NR RLC layer may include no concatenation function, which may be performed in the NR MAC layer or replaced with a multiplexing function of the NR MAC layer.

The out-of-sequence delivery of the NR RLC device may refer to instantly delivering RLC SDUs received from the lower layer to the upper layer regardless of the order, may include a function of reassembling and delivering multiple RLC SDUs received, into which one original RLC SDU has been segmented, and may include storing the RLC SN or PDCP SN of received RLC PDUs, and recording RLC PDUs lost as a result of reordering.

The NR MACs S40 and S55 may be connected to multiple NR RLC layer devices configured in one UE, and the main functions of the NR MACs may include at least one of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
Multimedia broadcast multicast service (MBMS) service identification
Transport format selection
Padding

The NR PHY layers S45 and S50 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

The structure of the radio protocol structure may be variously changed according to the carrier (or cell) operating scheme. As an example, assuming that the base station may transmit data to the UE based on a single carrier (or cell), the base station and the UE may use a protocol structure having a single structure with regard to each layer, such as the radio protocol structure S00. However, if the base station transmits data to the UE based on CA which uses multiple carriers in a single TRP, the base station and the UE may use a protocol structure which has a single structure up to the RLC, such as S10, but multiplexes the PHY layer through a MAC layer. As another example, if the base station transmits data to the UE based on DC which uses multiple carriers in multiple TRPs, the base station and the UE may use a protocol structure which has a single structure up to the RLC, such as S20, but multiplexes the PHY layer through a MAC layer.

As used herein, the UE may use various methods to determine whether to apply cooperative communication PDCCH(s) that allocates a PDSCH to which cooperative communication is applied have a specific format, or PDCCH(s) that allocates a PDSCH to which cooperative communication is applied include a specific indicator indicating whether to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to when the UE receives a PDSCH to which cooperative communication is applied, based on conditions similar to those described above.

Hereinafter, determining priority between A and B may be variously described as selecting an entity having a higher priority according to a predetermined priority rule and performing an operation corresponding thereto, or omitting or dropping operations regarding an entity having a lower priority.

Herein, upper layer signaling may refer to signaling corresponding to at least one signaling among at least one of the following signaling.
MIB
SIB or SIB X (X=1, 2, . . . )
RRC
MAC CE

In addition, layer 1 (L1) signaling may refer to signaling corresponding to at least one signaling method among signaling methods using at least one of the following physical layer channels or signaling.
PDCCH
DCI
UE-specific DCI
Group common DCI
Common DCI
Scheduling DCI (for example, DCI used for the purpose of scheduling DL or UL data)
Non-scheduling DCI (for example, DCI not used for the purpose of scheduling DL or UL data) PUCCH
UL control information (UCI)

### RB Set and Scheduled RB Set Determination Method

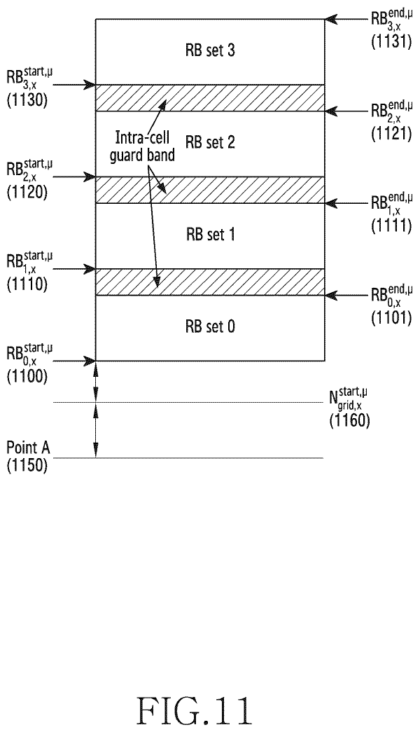

FIG. 11 illustrates an RB set according to an embodiment.

Referring to FIG. 11, RB sets and intra-cell guard band configurations in an unlicensed band may be described.

Multiple RB sets may be defined in the unlicensed band. RB sets may be defined as follows.

A base station may configure, for a terminal, an index (GB_{s,x}^{start,μ}) of a start common resource block (CRB) and the number (GB_{s,x}^{size,μ}) of consecutive CRBs, which correspond to an intra-cell guard band, on a UL carrier or a DL carrier at each subcarrier spacing (μ). One or multiple intra-cell guard bands may be configured for the terminal. That is, s=0, 1, 2, . . . may be satisfied. The terminal may determine RB sets based on a configuration of the inter-cell guard band. For reference, when the number of RB sets is NRB-set, the number of intra-cell guard band configurations may be NRB-set-1. A start CRB index and a last CRB index of RB sets may be determined as in Equation (2) below.

$$\begin{matrix}R {B}_{s , x}^{start , μ} = {N}_{grid , x}^{start , μ} + \{ \begin{matrix}0 & s = 0 \\ G {B}_{s - 1 , x}^{start , μ} + G {B}_{s - 1 , x}^{s i ze , μ} & otherwise\end{matrix} \\ {RB}_{s , x}^{e n d , μ} = {N}_{grid , x}^{start , μ} + \{ \begin{matrix}{N}_{grid , x}^{s i ze , μ} - 1 & s = {N}_{RB - set , x} - 1 \\ G {B}_{s , x}^{start , μ} - 1 & otherwise\end{matrix}\end{matrix} \qquad ( 2 )$$

In Equation (2), N_{grid,x}^{start,μ} tart may denote an index of a starting CRB used for transmission in a carrier, and N_{grid,x}^{start,μ} may denote the number of CRBs used for transmission in the carrier. For reference, here, x may be x=UL for an UL carrier, and x=DL for a DL carrier. When x=UL, RB sets may be referred to as UL RB sets. When x=DL, RB sets may be referred to as DL RB sets. Herein, whether the RB set is UL or DL may be omitted.

An RB set with index s may include RB_{s,x}^{start,μ} RBs, where RB_{s,x}^{start,μ}=_{s,x}^{end,μ}−RB_{s,x}^{start,μ}+1.

Referring to FIG. 11, three intra-cell guard bands may be configured for the terminal by the base station. The terminal may determine four RB sets of RB set 0, RB set 1, RB set 2, and RB set 3, based on the three configured intra-cell guard bands. RB set 0 is an RB set located at the lowest frequency. Indexes of start RBs of RB set 0, RB set 1, RB set 2, and RB set 3 may be RB_{0,x}^{start,μ} 1100, RB_{1,x}^{start,μ} 1110, RB_{2,x}^{start,μ} 1120, and RB_{3,x}^{start,μ} 1130, respectively, and indexes of last RBs may be RB_{0,x}^{end,μ} 1101, RB_{1,x}^{end,μ} 1111, RB_{2,x}^{end,μ} 1121, and RB_{3,x}^{end,μ} 1131, respectively. In FIG. 11, the start and last RB indexes of the RB set may be determined based on N_{grid,x}^{start,μ} determined from point A 1150.

When no intra-cell guard band is configured for the terminal by the base station, the terminal may determine the intra-cell guard band from Table 16 below.

TABLE 16

| SCS | | | |
|---|---|---|---|
| (kHz) | 40 MHz | 60 MHz | 80 MHz |
| 15 | 105-6-105 | N/A | N/A |
| | (216) | | |
| 30 | 50-6-50 | 50-6-50-6-50 | 50-6-50-5-50-6-50 |
| | (106) | (162) | (217) |
| 60 | 23-5-23 | 23-5-23-5-23 | 23-5-23-5-23-5-23 |
| | (51) | (79) | (107) |

NOTE 1:
The intra-cell guard band is denoted TBW₀-GB₀- . . . -GB_{N}_{_{—}}_{RBset-2}-TBW_{N}_{_{—}}_{RBset-1} for N_RBset > 1 number of RB − sets with TBWᵣ the maximum transmission bandwidth (PRB) of RB − set r and GBᵣ the guard band (PRB) above the upper edge of RB − set r. The RB − set 0 is starting at the first common resource block (CRB) of the carrier as indicated by offsetToCarrier. The total transmission bandwidth configuration (size of resource grid) including guard bands is given in between parentheses.

In Table 16, for a carrier having a band of 40 MHz and a subcarrier spacing of 30 kHz, a total of 106 CRBs may be included, 50 CRBs from CRB 0 may constitute RB set 0, 6 CRBs from CRB 50 may be an intra-cell guard band, and subsequent 50 CRBs from CRB 56 may constitute RB set 1.

The terminal may expect that a start RB of a BWP is the same as a start RB of a first RB set, and a last RB of the BWP is the same as a last RB of a second RB set. The first RB set and the second RB set may be identical or different. That is, when an index of the first RB set is s0 and an index of the second RB set is s1, s0≤s1 may be satisfied. The number of RB sets included in BWP may be referred to as N_{RB-set}^{BWP}.

Index s of the RB set described above may be referred to as a cell common RB set. When N_{RB-set}^{BWP} RB sets are included in the BWP, indexes of the RB sets in the BWP may be assigned based on the BWP. That is, among the RB sets in the BWP, the lowest RB set in the frequency domain may be referred to as RB set 0 of the BWP, and the indexes of the RB sets of the BWP may increase in ascending order of the frequency domain. In the frequency domain, the last RB set of the BWP may be referred to as RB set N_{RB-set}.

When it is assumed that the BWP includes cell common RB set s0, cell common RB set s0+1, . . . , and cell common RB set s1 (s0≤s1), cell common RB set s0 may match RB set 0 of the BWP. Cell common RB set s0+1 may match RB set 1 of the BWP. In addition, cell common RB set s1 may match RB set N_{RB-set}^{BWP} of the BWP.

One CRB may be generated by grouping 12 consecutive subcarriers in ascending order from a specific frequency position (point A) of the carrier, and the indexes may be assigned sequentially starting from 0 in ascending order of frequency. The CRB N may refer to a CRB with an index of N.

A DCI format for scheduling of a UL in an unlicensed band may determine RB sets in which a PUSCH is scheduled. In this case, there may be one or multiple scheduled RB sets.

A DCI format (e.g., DCI format 0_0) monitored in a CSS may schedule a PUSCH in one UL RB set within an active UL BWP. That is, when the terminal receives the DCI format monitored in the CSS, one RB set for transmission of the PUSCH scheduled by the DCI format may be determined within the active UL BWP. The DCI format monitored in CSS may not include a DCI field indicating a scheduled RB set. Therefore, the terminal is unable to determine a scheduled RB set, based on the DCI field of the DCI format.

If a CRC of the DCI format monitored in CSS is scrambled by an RNTI other than TC-RNTI, the terminal may determine, as a scheduled UL RB set, a UL RB set having the lowest index among at least one UL RB set overlapping with a CCE having the lowest index of a PDCCH including the DCI format within an active DL BWP. For reference, for the terminal, UL RB set(s) may be RB set(s) included in the UL BWP. If there is no at least one overlapping UL RB set, the terminal may determine, as a scheduled RB set, an RB set having the lowest index in the active UL BWP. The terminal may transmit the PUSCH scheduled by the DCI format within the determined one scheduled UL RB set.

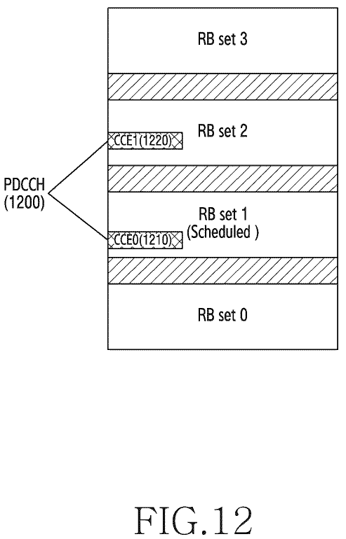

FIG. 12 illustrates scheduled RB set determination based on reception of a PDCCH according to an embodiment.

Referring to FIG. 12, a description may be provided for a method of scheduling a PUSCH by a DCI format monitored in CSS. A terminal may determine CCEs belonging to a PDCCH 1200 including a DCI format. CCE0 1210 and CCE1 1220 may be CCEs belonging to the PDCCH. Among the CCEs, CCE0 1210 may be determined to be a CCE having the lowest index. The terminal may determine RB set 1 to be an UL RB set that overlaps with CCE0 1210. Therefore, the terminal may determine that RB set 1 is an RB set in which a PUSCH is scheduled.

If a CRC of a DCI format monitored in CSS is scrambled by TC-RNTI, a scheduled RB set may be determined to be the same RB set as an RB set in which the terminal has transmitted a PRACH corresponding to an RAR UL grant. The terminal may assume that RB set(s) are determined according to Table 16 described above.

A DCI format monitored in a USS may schedule a PUSCH in one or multiple UL RB set(s) within an UL BWP. The scheduled RB set(s) may be consecutive RB sets. The DCI format monitored in USS may include a DCI field of Y bits to indicate one or multiple scheduled RB set(s). Y bits may be determined as shown in Equation (3) below.

$$Y = ceil ( {log}_{2} \frac{{N}_{R B - set , UL}^{B W P} ( {N}_{R B - set , UL}^{B W P} + 1 )}{2} ) \qquad ( 3 )$$

In Equation (3), N_{RB-set,UL}^{BWP} may be the number of UL RB sets included in an active UL BWP. The Y bits may include a resource indication value (RIV_{RB-set}), and the resource indication value may be

$${RIV}_{R B - set} = 0 , 1 , … , \frac{{N}_{R B - set , UL}^{BWP} ( {N}_{R B - set , UL}^{B W P} + 1 )}{2} - 1.$$

The resource indication value may be defined as shown in Table 17 below. N_{RB-set,UL}^{BWP} may be an index of a start UL RB set, and L_{RB-set} may be the number of consecutive UL RB sets.

```
TABLE 17
if (L_{RB-set} − 1) ≤ └N_{RB-set,UL}^{BWP}/2┘ then
  RIV_{RB-set} = N_{RB-set,UL}^{BWP}(L_{RB-set} − 1) + N_{RB-set,UL}^{start}
else
  RIV_{RB-set} = N_{RB-set,UL}^{BWP}(N_{RB-set,UL}^{BWP} − L_{RB-set} + 1) + (N_{RB-set,UL}^{BWP} − 1 − N_{RB-set,UL}^{start})
where N_{RB-set,UL}^{start} = 0,1, ... N_{RB-set,UL}^{BWP} − 1, L_{RB-set} ≥ 1 and shall not exceed N_{RB-set,UL}^{BWP} − N_{RB-set,UL}^{start}
```

### Embodiment 1: Method of Determining a Scheduled RB Set by DCI Format Monitored in CSS

As described above, when a DCI format monitored in CSS is scrambled by an RNTN other than TC-RNTI, the terminal may determine, as a scheduled RB set, a lowest UL RB set among UL RB sets overlapping with a CCE having the lowest index of a PDCCH including the DCI format monitored in CSS. In addition, when there is no overlapping UL RB set, RB set 0 in an active BWP may be determined to be a scheduled RB set.

The terminal may configure different intra-cell guard bands for a UL carrier and a DL carrier. For example, when it is assumed that a DL carrier and an UL carrier include 106 CRBs (e.g., a subcarrier spacing of 30 kHz and a carrier bandwidth of 40 MHz in Table 16 are assumed), the terminal may not configure an intra-cell guard band for DL. That is, the terminal may consider the entire 40 MHz as one DL RB set. The terminal may configure an intra-cell guard band for UL. For example, the terminal may configure 6 central RBs among 106 CRBs to be an intra-cell guard band, in which case, CRB 0 to CRB 49 may be included in UL RB set 0, CRB 50 to CRB 55 may be the intra-cell guard band, and CRB 56 to CRB 105 may be included in UL RB set 1. As described above, some RBs of the DL carrier may overlap with the intra-cell guard band of the UL carrier. Therefore, when the DCI format monitored in CSS is scrambled by an RNTI other than TC-RNTI, a UL resource overlapping with the CCE having the lowest index of the PDCCH including the DCI monitored in CSS may be the intra-cell guard band. In this case, the terminal may have ambiguity in determining UL RB set overlapping with the CCE having the lowest index.

The CCE includes 2, 3, or 6 RBs in the frequency domain, and may thus completely overlap with the intra-cell guard band including 6 RBs in the example above.

It is noted that the disclosure may be applied when a UL resource overlapping with a CCE having the lowest index is an inter-cell guard band.

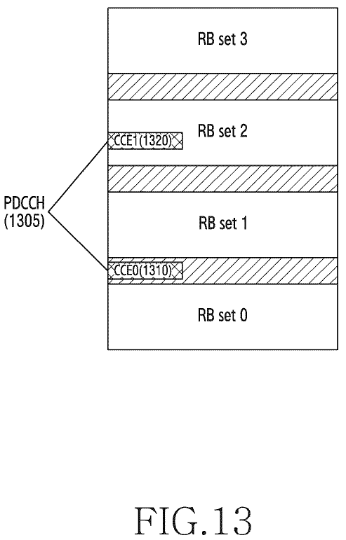

FIG. 13 illustrates when an RB set cannot be determined when a PDCCH is received according to an embodiment.

Referring to FIG. 13, a description may be provided for a method of scheduling a PUSCH by a DCI format monitored in CSS. A terminal may determine CCEs belonging to a PDCCH 1300 including a DCI format. CCE0 1310 and CCE1 1320 may belong to the PDCCH. The terminal may determine CCE0 1310 as a CCE having the lowest index among the CCEs. The terminal may determine that CCE0 1310 completely overlaps with an intra-cell guard band. Therefore, the terminal is unable to determine an overlapping UL RB set, based on CCE0 1310.

The terminal may not expect to receive a PDCCH. For example, when a CCE having the lowest index of a PDCCH candidate monitored in an active DL BWP completely overlaps with a UL intra-cell guard band, the terminal may be assumed that the PDCCH candidate does not include DCI for scheduling of a UL PUSCH. If the terminal receives the DCI for scheduling of the UL PUSCH in the described PDCCH, the terminal may determine that the DCI is incorrect (error or inconsistent) DCI and discard the DCI. For example, the terminal may not perform an operation indicated by the DCI.

The number of PDCCH candidates via which the terminal may receive PUSCH scheduling may be reduced. Accordingly, the number of blind decoding cases of the terminal may be reduced, thereby reducing power consumption of the terminal. However, since the number of PDCCH candidates via which the terminal may receive PUSCH scheduling is reduced, a PDCCH blocking problem may occur.

Herein, when a CCE having the lowest index completely overlaps with an intra-cell guard band, the terminal may determine a scheduled UL RB set by using another CCE.

For example, the another CCE here may be a CCE having the second lowest index. If the CCE having the second lowest index overlaps with at least one UL RB set, the terminal may determine, as a scheduled UL RB set, an UL RB set having the lowest index among UL RB sets.

For example, the terminal may determine a CCE overlapping with at least one UL RB set in ascending order of indexes of CCEs. For example, when both the CCE having the lowest index and the CCE having the second lowest index completely overlap with the intra-cell guard band, and a CCE having the third lowest index overlaps with at least one UL RB set, the terminal may determine a scheduled UL RB set, based on the CCE having the third lowest index. For example, the terminal may determine that an RB set having the lowest index among UL RB sets overlapping with the CCE having the third lowest index is a scheduled UL RB set. The terminal may perform repetition in ascending order of CCE indexes of a received PDCCH until the terminal finds a scheduled UL RB set.

For example, the terminal may determine a scheduled UL RB set by using an CCE having the highest index. The terminal may determine that an RB set with the lowest index among UL RB sets overlapping with a CCE having the highest index is a scheduled UL RB set.

If the terminal is unable to determine a scheduled UL RB set based on CCEs, the terminal may determine that an RB set having the lowest index within an active UL BWP is a scheduled UL RB set.

As a method of determining a scheduled UL RB set, an intra-cell guard band configured on a UL subcarrier may be connected to an adjacent UL RB set. Therefore, the terminal may determine an RB set connected to the intra-cell guard band even if a CCE overlaps with the intra-cell guard band.

The intra-cell guard band may be connected to an RB set having a lower index among adjacent RB sets. For example, the intra-cell guard band configured between RB set 0 and RB set 1 may be connected to RB set 0. When the CCE having the lowest index completely overlaps with the intra-cell guard band, the terminal may determine, as a scheduled UL RB set, an UL RB set having the lower index among two UL RB sets adjacent to the intra-cell guard band.

The intra-cell guard band may be connected to an RB set having a higher index among adjacent RB sets. For example, the intra-cell guard band configured between RB set 0 and RB set 1 may be connected to RB set 1. When the CCE having the lowest index completely overlaps with the intra-cell guard band, the terminal may determine, as a scheduled UL RB set, an UL RB set having the higher index among the two UL RB sets adjacent to the intra-cell guard band.

Some RBs adjacent to the RB set having the low index in the intra-cell guard band may be connected to the RB set having the low index, and some RBs adjacent to the RB set having the high index in the intra-cell guard band may be connected to the RB set having the high index. For example, when the intra-cell guard band configured between RB set 0 and RB set 1 includes N RBs, low N/2 (or floor(N/2), ceil(N/2)) RBs in the frequency domain may be connected to RB set 0, and high N-N/2 (or N-floor(N/2), N-ceil(N/2)) RBs in the frequency domain may be connected to RB set 1. When the CCE having the lowest index completely overlaps with the intra-cell guard band, the terminal may determine whether the CCE overlaps with first RBs or overlaps with second RBs of the intra-cell guard band. The first RBs may be low N/2 (or floor(N/2), ceil(N/2)) RBs in the frequency domain, and the second RBs may be high N-N/2 (or N-floor(N/2), N-ceil(N/2)) RBs in the frequency domain. If the CCE overlaps with the first RBs, the terminal may determine, as a scheduled UL RB set, the UL RB set having the lower index among the two UL RB sets adjacent to the intra-cell guard band. If the CCE overlaps with the second RBs, the terminal may determine, as a scheduled UL RB set, the UL RB set having the higher index among the two UL RB sets adjacent to the intra-cell guard band.

The terminal may determine a UL RB set as a scheduled UL RB set. For example, when the lowest CCE completely overlaps with the intra-cell guard band, the terminal may assume that a determined UL RB set has been scheduled.

The determined UL RB set may be RB set 0 of the active UL BWP.

The determined UL RB set may be configured for each UL BWP by the base station. For example, when the UL BWP of the terminal includes multiple UL RB sets, one RB set among the multiple UL RB sets may be configured as a scheduled UL RB set by the base station.

The determined UL RB set may be an RB set of an initial UL BWP. If the initial UL BWP includes multiple RB sets, the determined UL RB set may be an RB set having the lowest index.

This may be applied when the active UL BWP includes the initial UL BWP. If the active UL BWP includes no initial UL BWP, the determined UL RB set may be determined by a different method.

The determined UL RB set may be determined to be an UL RB set corresponding to PRACH transmission. If the UL RB set corresponding to PRACH transmission is not included in the active UL BWP, the determined UL RB set may be determined by a different method.

The determined UL RB set may be an UL RB set in which a PUSCH has been scheduled via DCI that the terminal has received immediately before. If the PUSCH is scheduled in multiple RB sets via the DCI that was received by the terminal immediately before, an UL RB set having the lowest index among the RB sets may be determined as a scheduled UL RB set.

### DCI Length Alignment

For an NR terminal, the number of DCI formats having different lengths may be determined to reduce complexity of blind decoding. For example, a DCI format scrambled by C-RNTI may allow up to three different lengths, and a total of four DCI format lengths may be allowed. This may be referred to as DCI size budget.

If the number of DCI formats having different lengths monitored by the NR terminal exceeds a DCI size budget, the terminal may align the lengths of some DCI formats to be the same.

A series of such procedures may be referred to as DCI length alignment.

### Step 0:

DCI format 0_0 monitored in a CSS is determined. N_{RB}^{UL,BWP} may be a size of the initial UL BWP.

DCI format 1_0 monitored in the common search space is determined. N_{RB}^{UL,BWP} may be a size of CORESET 0 when CORESET 0 is configured in a cell, and may be a size of an initial DL BWP when CORESET 0 is not configured in the cell.

If DCI format 0_0 is monitored in the common search space, and the number of pre-padding information bits of DCI format 0_0 is less than the length of DCI format 1_0 monitored in the common search space for scheduling of the same serving cell, some zero padding bits may be generated for DCI format 0_0 so that the length of DCI format 0_0 may be changed to be equal to that of DCI format 1_0.

If DCI format 0_0 is monitored in the common search space, and the number of pre-padding information bits of DCI format 0_0 is greater than the length of DCI format 1_0 monitored in the common search space for scheduling of the same serving cell, the terminal may cut off most significant bits (MSBs) of the frequency domain resource assignment field in DCI format 0_0 so as to make the size of DCI format 0_0 to be equal to the size of DCI format 1_0.

### Step 1:

DCI format 0_0 monitored in a UE-specific search space (USS) may be determined according to N_{RB}^{UL,BWP} which is a size of the active UL BWP.

DCI format 1_0 monitored in the UE-specific search space may be determined according to N_{RB}^{UL,BWP} which is a size of the active DL BWP.

A UE configured with supplementaryUplink in ServingCellConfig of a cell may be configured so that a PUSCH is transmitted in both SUL and non-SUL of the cell, and if the number of information bits of DCI format 0_0 in the UE-specific search space for SUL is not equal to the number of information bits of DCI format 0_0 in the UE-specific search space for non-SUL, some zero padding bits may be generated for DCI format 0_0 with fewer information bits until the length thereof becomes equal to that of DCI format 0_0 with more information bits.

If DCI format 0_0 is monitored in the UE-specific search space, and the number of information bits of DCI format 0_0 before padding is less than the length of DCI format 1_0 monitored in the UE-specific search space for scheduling of the same serving cell, some zero padding bits may be generated for DCI format 0_0.

If DCI format 1_0 is monitored in the UE-specific search space, and the number of information bits of DCI format 1_0 before padding is less than the length of DCI format 0_0 monitored in the UE-specific search space for scheduling of the same serving cell, the terminal may adjust the length of DCI format 10 until the length becomes equal to that of DCI format 0_0 by adding zeros.

### Step 2:

DCI format 0_1 monitored in the UE-specific search space may be determined according to section 7.3.1.1.2 in 3GPP standard document TS 38.212.

DCI format 1_1 monitored in the UE-specific search space may be determined according to section 7.3.1.2.2 in 3GPP standard document TS 38.212.

The UE configured with supplementaryUplink in ServingCellConfig of the cell may be configured so that a PUSCH is transmitted in both SUL and non-SUL of the cell, and if the number of information bits of DCI format 0_1 for SUL is not equal to the number of information bits of DCI format 0_1 for non-SUL, zeros may be added to DCI format 0_1 with fewer information bits so that the length thereof may be equal to that of DCI format 0_1 with more information bits.

If the size of DCI format 0_1 monitored in the UE-specific search space is equal to the size of DCI format 0_0/1_0 monitored in another UE-specific search space, 1-bit padding bit “0” may be added to DCI format 0_1.

If the size of DCI format 1_1 monitored in the UE-specific search space is equal to the size of DCI format 0_0/1_0 monitored in another UE-specific search space, 1-bit padding bit “0” may be added to DCI format 1_1.

### Step 2A:

DCI format 0_2 monitored in the UE-specific search space may be determined according to section 7.3.1.1.3 in 3GPP standard document TS 38.212.

DCI format 1_2 monitored in the UE-specific search space may be determined according to section 7.3.1.2.3 in 3GPP standard document TS 38.212.

The UE configured with supplementaryUplink in ServingCellConfig of the cell may be configured so that a PUSCH is transmitted in both SUL and non-SUL of the cell, and if the number of information bits of DCI format 0_2 for SUL is not equal to the number of information bits of DCI format 0_2 for non-SUL, “0” may be added to DCI format 0_2 with fewer information bits until the length thereof becomes equal to that of DCI format 0_2 with more information bits.

### Step 3:

If both of the following conditions are met, DCI length alignment may be completed.

If the total number of different DCI sizes to be monitored in the cell is 4 or less,

If the total number of different DCI sizes configured by C-RNTI in the cell is 3 or less

### Step 4:

Otherwise,

### Step 4A:

The padding bit (if any) introduced in step 2 may be removed.

DCI format 1_0 monitored in the UE-specific search space may be determined. N_{RB}^{UL,BWP} may be the size of CORESET 0 when CORESET 0 is configured in the cell, and may be the size of the initial DL BWP when CORESET 0 is not configured in the cell.

DCI format 0_0 monitored in the UE-specific search space may be determined. N_{RB}^{UL,BWP} may be the size of the initial UL BWP.

If the number of information bits of DCI format 0_0 monitored in the UE-specific search space to schedule the same service cell as that for the length of DCI format 1_0 monitored in the UE-specific search space is less before padding, some zero padding bits may be generated until the length of DCI format 0_0 becomes equal to that monitored in DCI format 1_0.

To schedule the same service cell as that monitored in the DCI format 1_0 before cutting off of the number of information bits in DCI format 0_0 monitored in the UE-specific search space, the bit width of the frequency domain resource assignment field of DCI format 0_0 may be reduced. The size of DCI format 0_0 may be changed to be equal to be the size of DCI format 1_0 monitored in the UE-specific search space.

### Step 4B:

If, after applying the above steps, the total number of different DCI lengths to be monitored in the cell is 4 or more, or the total number of different DCI lengths configured by C-RNTI is 3 or more,

If the number of information bits of DCI format 0_2 before padding is less than the length of DCI format 1_2 for scheduling of the same serving cell, a certain number of zero padding bits may be generated for DCI format 0_2 until the length thereof becomes equal to the length of DCI format 1_2.

If the number of information bits of DCI format 1_2 before padding is less than the length of DCI format 0_2 for scheduling of the same serving cell, zeros may be added for DCI format 1_2 until the length of DCI format 1_2 is equal to the length of DCI format 0_2.

### Step 4C:

After performing the above steps, if the total number of different DCI lengths to be monitored in the cell is 4 or more, or the total number of different DCI lengths configured by C-RNTI is 3 or more,

If the number of information bits of DCI format 0_1 before padding is less than the length of DCI format 0_1 used for scheduling the same serving cell by using DCI format 1_1, a certain number of zero padding bits may be generated for DCI format 0_1.

If the number of information bits of DCI format 1_1 before padding is less than the length of DCI format 1_1 used for scheduling the same serving cell by using DCI format 0_1, zeros may be added for DCI format 1_1.

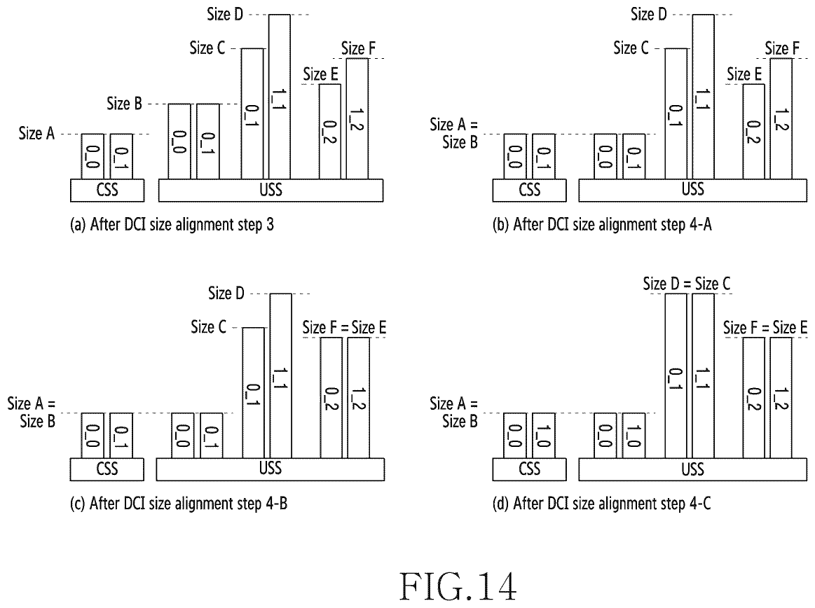

FIG. 14 illustrates a DCI length alignment according to an embodiment.

Referring to FIG. 14, after above-described step 3, the lengths of the different DCI formats of the terminal are the lengths (size A) of DCI format 0_0 and DCI format 1_0 monitored in CSS, the lengths (size B) of DCI format 0_0 and DCI format 1_0 monitored in USS, the length (size C) of DCI format 0_1, the length (size D) of DCI format 1_1, the length (size E) of DCI format 0_2, and the length (size F) of DCI format 1_2. Therefore, the terminal may have up to six different DCI format lengths.

In step 4-A, the lengths (size B) of DCI format 0_0 and DCI format 1_0 monitored in USS may be aligned to be equal to the lengths (size A) of DCI format 0_0 and DCI format 1_0 monitored in CSS. Accordingly, size B may be adjusted to satisfy size A=size B. Therefore, after step 4-A, the terminal may have up to 5 different DCI format lengths.

In step 4-B, the length (size E) of DCI format 0_2 and the length (size F) of DCI format 1_2 may be aligned to be equal. If the length (size F) of DCI format 1_2 is longer than the length (size E) of DCI format 0_2_the length (size E) of DCI format 0_2 may be changed to become the length (size F) of DCI format 1_2. That is, size F=size E may be satisfied. Therefore, after step 4B, the terminal may have up to 4 different DCI format lengths.

In step 4-C, the length (size C) of DCI format 0_1 and the length (size D) of DCI format 1_1 may be aligned to be equal. If the length (size D) of DCI format 1_1 is longer than the length (size C) of DCI format 0_1, the length (size C) of DCI format 0_1 may be changed to become the length (size D) of DCI format 1_1. That is, size D=size C may be satisfied. Therefore, after step 4-C, the terminal may have up to 3 different DCI format lengths.

As described above, the terminal may have up to 3 different DCI formats (scrambled by C-RNTI).

### Embodiment 2: Method of Determining Scheduled RB Sets by DCI Format Monitored in USS

DCI format 0_0 monitored in USS by the terminal may include Y bits indicating UL RB set(s) in which a PUSCH is scheduled. Y bits may be determined via Equation (4) as follows:

$$Y = ceil ( {log}_{2} ( {N}_{R B - set , UL}^{B W P} ( {N}_{R B - set , UL}^{B W P} + 1 ) / 2 ) ) \qquad ( 4 )$$

In Equation (4) N_{RB-set,UL}^{BWP} denotes the number of UL RB sets included in the active UL BWP. For example, if the number of RB sets included in the active UL BWP is 4, Y=4 bits may be satisfied.

For DCI format 0_0 monitored in USS by the terminal, step 4A of DCI length alignment may be performed. In step 4A, when determining the length of DCI format 0_0 monitored in USS, the initial UL BWP may be used instead of the active UL BWP. In other words, for the Y bits indicating the UL RB set(s), the number of RB sets included in the initial UL BWP may be used. That is, in Equation (4), N_{RB-set,UL}^{BWP} may be the number of RB sets included in the initial UL BWP.

For description purposes, if Y_{active}=ceil(log₂(N_{active,UL}^{BWP}(N_{active,UL}^{BWP}+1)/2)) and Yᵢₙᵢₜᵢₐₗ=ceil(log₂(N_{initial,UL}^{BWP}(N_{initial,UL}^{BWP}+1)/2)), Y_{active} may be bits to indicate scheduled RB set(s) among N_{active,UL}^{BWP} RB sets within the active UL BWP in DCI format 0_0, and Yᵢₙᵢₜᵢₐₗ may be bits included in DCI format 0_0 according to step 4A of DCI alignment. In this case, N_{initial,UL}^{BWP} may be the number of RB sets included in the initial UL BWP. For example, Y_{active}=4 when the number of RB sets included in the active UL BWP is 4, and Yᵢₙᵢₜᵢₐₗ=0 when the number of RB sets included in the initial UL BWP is 1.

The following describes determining scheduled RB set(s) by DCI format 0_0 when the terminal receives Yᵢₙᵢₜᵢₐₗ in DCI format 0_0 monitored in USS.

First, when Yᵢₙᵢₜᵢₐₗ=0, scheduled UL RB set(s) may be determined via the following method.

The terminal may use the same method as the method for determining a scheduled UL RB set in DCI format 0_0 monitored in CSS. That is, if Y bits indicating UL RB sets in DCI format 0_0 monitored in USS are 0, the terminal may determine, as a scheduled UL RB set, an RB set having the lowest index among at least one UL RB set overlapping with a CCE having the lowest index of the PDCCH including DCI format 0_0 monitored in USS. If at least one UL RB set does not overlap with the CCE having the lowest index of the PDCCH including DCI format 0_0 monitored in USS, a UL RB set having the lowest index within the active UL BWP may be determined as a scheduled UL RB set.

For example, N_{active,UL}^{BWP} UL RB sets are included in the active UL BWP of the terminal. However, since DCI format 0_0 monitored in USS has no bit capable of indicating RB sets, the same method as that for DCI format 0_0 monitored in CSS may be used. Therefore, only one UL RB set may be used for UL scheduling.

If DCI format 0_0 monitored in USS has no bit capable of indicating RB sets, the terminal may determine that an RB set having the lowest index among RB sets included in the active UL BWP is a scheduled RB set according to DCI format 0_0 monitored in USS. Also in this method, only one UL RB set may be used for UL scheduling.

As a method of UL scheduling one or more RB sets, the terminal may determine that all UL RB sets overlapping with CCEs of the lowest index of the PDCCH including DCI format 0_0 are scheduled RB sets. For example, if the CCEs having the lowest index of the PDCCH received by the terminal overlap with two RB sets in the active UL BWP, the terminal may determine that the two RB sets are scheduled UL RB sets.

As a method of UL scheduling one or more RB sets, the terminal may determine that all UL RB sets overlapping with all CCEs of the PDCCH including DCI format 0_0 are scheduled RB sets. For example, if all the CCEs of the PDCCH received by the terminal overlap with two RB sets in the active UL BWP, the terminal may determine that the two RB sets are scheduled UL RB sets.

As a method of UL scheduling one or more RB sets, when DCI format 0_0 is received, the terminal may determine that all UL RB sets within the active UL BWP are scheduled UL RB sets. For example, if four UL RB sets are included in the active UL BWP, the four UL RB sets may be determined as scheduled RB sets.

In the aforementioned methods, the terminal has determined scheduled RB sets without higher-layer signaling from a base station. The terminal may receive an indication of RB sets available for scheduling, from the base station via higher-layer signaling. For example, the base station may use a higher-layer signal to configure, for the terminal, RB sets available for scheduling within the active UL BWP. Alternatively, the base station may use a physical layer signal (e.g., a DCI format or a MAC-CE signal) to indicate, to the terminal, RB sets available for scheduling within the active UL BWP. In this case, UL RB sets indicated by DCI format 0_0 monitored in USS may be determined from among the RB sets available for scheduling. If Yᵢₙᵢₜᵢₐₗ≥Y_{active}, scheduled UL RB set(s) may be determined via the following method.

The terminal may determine Y_{active} bits among Yᵢₙᵢₜᵢₐₗ bits to be valid bits. For example, the terminal may determine LSB Y_{active} bits among Yᵢₙᵢₜᵢₐₗ bits to be valid bits. The terminal may determine that MSB Y_{active} bits among Yᵢₙᵢₜᵢₐₗ bits to be valid bits. The terminal may obtain an RIV value via Y_{active} bits determined to be valid. The terminal may analyze the RIV value to determine an index of a start RB set and the number of consecutive RB sets. The terminal may use Table 17 above when analyzing the RIV value, where N_{RB-et,UL}^{BWP} may be the number of UL RB sets included in the active UL BWP.

If 0<Yᵢₙᵢₜᵢₐₗ<Y_{active}, at least one bit, based on which the terminal determines scheduled UL RB set(s), is included in DCI format 0_0, but the bit may not be sufficient. In this case, the terminal may determine RB set(s) via the following method.

The terminal may use the same method as the method for determining a scheduled UL RB set in DCI format 0_0 monitored in CSS. That is, if Yᵢₙᵢₜᵢₐₗ bits indicating UL RB sets in DCI format 0_0 monitored in USS are insufficient to indicate RB sets included in the active UL BWP, the terminal may determine, as a scheduled UL RB set, an RB set having the lowest index among at least one UL RB set overlapping with the CCE having the lowest index of the PDCCH including DCI format 0_0 monitored in USS. If there is no at least one UL RB set overlapping with the CCE having the lowest index of the PDCCH including DCI format 0_0 monitored in USS, the terminal may determine, as a scheduled UL RB set, the UL RB set having the lowest index within the active UL BWP. In this case, even though there are Yᵢₙᵢₜᵢₐₗ bits indicating an UL RB set in DCI format 0_0, the Yᵢₙᵢₜᵢₐₗ bits may be disregarded.

The terminal may select N RB sets from among the RB sets included in the active UL BWP. The selected N RB sets may be RB sets having consecutive indexes. N may be selected as in the following example.

N may be equal to the number of RB sets included in the initial UL BWP. For example, the terminal may select, from the active UL BWP, the same number of RB sets as the number of the RB sets included in the initial UL BWP. For example, when it is assumed that the active UL BWP includes 6 RB sets and the initial UL BWP includes 4 RB sets, and if the length of the field indicating RB sets is determined as Yᵢₙᵢₜᵢₐₗ=4(=ceil(log₂(4*5/2))) by DCI length alignment, the terminal may determine that N=4.

N may be the lower of the number of the RB sets included in the active UL BWP and a largest value among natural numbers X satisfying ceil(log₂(X*(X+1)/2))≤Yᵢₙᵢₜᵢₐₗ. For example, when it is assumed that the active UL BWP includes 6 RB sets and the initial UL BWP includes 4 RB sets, and if the length of the field indicating RB sets is determined as Yᵢₙᵢₜᵢₐₗ=4(=ceil(log₂(4*5/2))) by DCI length alignment, the terminal may select 5 as the largest value among natural numbers X satisfying ceil(log₂(X*(X+1)/2))≤Yᵢₙᵢₜᵢₐₗ. Since 5 is less than the number of the RB sets included in the active UL BWP, N=5 may be satisfied. According to this method, the terminal may select a larger number of RB sets.

The terminal may select N RB sets from the active UL BWP, based on the determined N value.

The terminal may select N RB sets having the lowest index included in the active UL BWP. That is, RB set 0, RB set 1, . . . , and RB set N−1 included in the active UL BWP may be selected.

The terminal may select N RB sets having the highest index included in the active UL BWP. For example, RB set M-1, RB set M-2, . . . , and RB set M-N+1 included in the active UL BWP may be selected. The active UL BWP includes M RB sets which are RB set 0, RB set 1, . . . , and RB set M-1.

The terminal may select N RB sets, based on the CCE having the lowest index of the PDCCH including the received DCI format. For example, the RB set having the lowest index among the UL RB sets overlapping with the CCE of the lowest index of the PDCCH may be referred to as a reference RB set. According to this method, the terminal may select N−1 RB sets which include the RB set having the lowest index among the UL RS sets overlapping with the CCE of the lowest index of the PDCCH and are adjacent to (For example, the guard band may be contiguous with the UL RB set in the frequency domain.)a UL RB set including the RB set having the lowest index. For example, the terminal may select RB sets with consecutively high indexes, including the reference RB set. If there are N−1 or more RB sets with high indexes, the terminal may select the reference RB set and N−1 RB sets with consecutively high indexes. If there are fewer than N−1 RB sets with high indexes (e.g., if there are K RB sets with high indexes), the terminal may select, for the remaining N−(K+1) RB sets, the reference RB set and RB sets with consecutively low indexes, including the reference RB set. If there are N−1 or more RB sets with low indexes, the terminal may select the reference RB set and N−1 RB sets with consecutively low indexes. If there are fewer than N−1 RB sets with low indexes (e.g., if there are K RB sets with low indexes), the terminal may select, for the remaining N−(K+1) RB sets, the reference RB set and RB sets with consecutively high indexes.

The terminal may determine Yᵢₙᵢₜᵢₐₗ bits to be a resource indication value of the selected N RB sets. More specifically, if the lowest index among the N selected RB sets is R, the index may refer to the index of the RB sets in the UL active BWP. Yᵢₙᵢₜᵢₐₗ bits may have one value among start RB set indexes N_{RB-set,UL}^{start}=R, R+1, . . . , R+N−1 and one value among RB set lengths L_{RB-set}+1, 2, . . . , N. The resource indication value indicated by Yᵢₙᵢₜᵢₐₗ bits may be determined as shown in Table 18 below.

```
TABLE 18
if (L_{RB-set} − 1) ≤ └N/2┘ then
  RIV_{RB-set} = N(L_{RB-set} − 1) + (N_{RB-set,UL}^{start} − R)
else
  RIV_{RB-set} = N(N − L_{RB-set} + 1) + (N − 1 − (N_{RB-set,UL}^{start} − R))
where N_{RB-set,UL}^{start} = R, R + 1, ... , R + N − 1, L_{RB-set} ≥ 1 and shall not exceed N − (N_{RB-set,UL}^{start} − R)
```

For reference, the equations in Table 18 above may use the indexes of the RB sets of active UL BWP. The terminal may newly index the selected N RB sets. Among the N selected RB sets, an RB set having the lowest frequency may be referred to as RB set 0, and the terminal may index the RB sets in ascending order of frequency. The indexes of the RB sets may have one of the values that are 0, 1, 2, . . . , and N−1. Based on the indexes, the resource indication value indicated by Yᵢₙᵢₜᵢₐₗ bits may be determined as follows. In Table 19 below N_{RB-set,selected}^{start} may be indexes generated with the N selected RB sets. One value among N_{RB-set,selected}^{start}=0, 1, . . . , N−1 may be available. One value among L_{RB-set}+1, 2, . . . , N may be available.

```
TABLE 19
if (L_{RB-set} − 1) ≤ └N/2┘ then
  RIV_{RB-set} = N(L_{RB-set} − 1) + N_{RB-set,selected}^{start}
else
  RIV_{RB-set} = N(N − L_{RB-set} + 1) + (N − 1 − N_{RB-set,selected}^{start})
where N_{RB-set,selected}^{start} = 0,1, ... , N − 1, L_{RB-set} ≥ 1 and shall not exceed N − N_{RB-set,selected}^{start}
```

### AL8/AL16 Ambiguity

Disclosed herein is a method of RB set determination according to monitoring of PDCCH repetition transmission when PDCCH repetition transmission is configured for the terminal.

The base station may repeatedly transmit a PDCCH to provide higher PDCCH reception reliability to the terminal. The repeatedly transmitted PDCCH may include the same DCI. For convenience herein, repeated transmission of the PDCCH may be referred to as PDCCH repetition transmission. The base station may configure at least one piece of information as follows (e.g., first information, second information, third information, etc.) for the terminal for PDCCH repetition transmission.

The base station may configure two or more search spaces for the terminal by using the first information. The terminal may monitor (receive) the PDCCH via blind decoding in the search spaces. The respective search spaces may be distinguished by different unique indexes (or identities (IDs)). Configurations of the respective search spaces may include at least one of the following information. Search space configurations may include information on CORESETs to which the search spaces belong. For example, the respective search spaces may belong to the same CORESET or may belong to different CORESETs. The search space configurations may include information on the number of PDCCH candidates for each AL in the search spaces. At least 1, 2, 4, 8, and 16 ALs may be supported. The search space configurations may include information on symbols (i.e., time) for a PDCCH monitoring occasion (MO). The described information may include information on slot-basis periodicity and offset and a symbol in which the PDCCH monitoring occasion starts within a slot. In this case, the information on the symbol in which the PDCCH monitoring occasion starts within the slot may be indicated using a bitmap (e.g., 14-bit), and an Nth bit of the bit map may indicate whether the PDCCH monitoring occasion starts at an Nth OFDM symbol in the slot. If the Nth bit of the bitmap is “1”, the PDCCH monitoring opportunity may start at the Nth OFDM symbol in the slot. If the Nth bit of the bitmap is “0”, the PDCCH monitoring occasion may not start at the Nth OFDM symbol in the slot.

The base station may configure two or more search spaces, in which the PDCCH is to be repeatedly transmitted, for the terminal by using the second information or by using the indexes of the two or more search spaces. In this case, the search spaces in which the PDCCH is repeatedly transmitted may be expressed as being linked to each other. The two linked search spaces may have the same AL (e.g., 1, 2, 4, 8, or 16) and the same number of PDCCH candidates per AL.

More specifically, the second information may be configured in two methods as follows.

First configuration method: The base station may configure a search space group for PDCCH repetition transmission, and the search space group may include at least two search spaces. The search space group may be distinguished by a unique index (or identity (ID)). The search spaces included in the search space group may be configured via unique indexes of the search spaces. For example, the base station may configure search space group 1 for PDCCH repetition transmission, and may configure, for the terminal, {1, 2} which are the indexes of the respective search spaces to include search space 1 and search space 2 in search space group 1. In other words, {1, 2} which are the indexes of the search spaces may be configured to correspond to the index of search space group 1.

Second configuration method: When configuring respective search spaces for PDCCH repetition transmission, the base station may configure indexes of the search spaces, which are linked to the respective search spaces. For example, to link search space 1 and search space 2, the base station may include, when configuring search space 1, information that search space 2 is linked to the configuration of the search space 1. The base station may include, when configuring search space 2, information that search space 1 is linked to the configuration of the search space 2. Herein, “information of being linked” may be the index of the linked search space. In addition, when configuring the respective search spaces, the base station may configure a unique index of a search space group, which includes the search spaces and the linked search spaces. In the example above, when configuring search space 1, the base station may perform configuration to include information (e.g., the index of search space 2) that search space 2 is linked to the configuration of search space 1, and information (e.g., the index of search space group 1) that search space 1 and search space 2 are included in search space group 1. When configuring search space 2, the base station may perform configuration to include information (e.g., the index of search space 1) that search space 1 is linked to the configuration of search space 2, and information (e.g., the index of search space group 1) that search space 2 and search space 1 are included in search space group 1. Herein, “information of being included in the search space group” may be the index of the linked search space.

As described above, the two linked search spaces may have the same AL (e.g., 1, 2, 4, 8, or 16) and the same number of PDCCH candidates per AL. The terminal may assume that the same DCI is transmitted in PDCCH candidates corresponding to the same index of the same AL (e.g., 1, 2, 4, 8, or 16) in the two search spaces. As a specific example, the linked search spaces may be assumed to be search space 1 and search space 2. It may be assumed that, in search space 1 and search space 2, two PDCCH candidates (index 32 0 and index=1) with AL 4 may be configured, and a PDCCH candidate (index=0) with AL 8 may be configured. In this case, the same DCI may be transmitted in first PDCCH candidates (index=0) in which search space 1 and search space 2 have AL 4, the same DCI may be transmitted in second PDCCH candidates (index=1) in which search space 1 and search space 2 have AL 4, and the same DCI may be transmitted in PDCCH candidates (index=0) in which search space 1 and search space 2 have AL 8. Therefore, the terminal may receive the same DCI from the PDCCH candidates of the respective search spaces, based on the same AL (e.g., 1, 2, 4, 8, or 16) and the same number of PDCCH candidates per AL of the linked search spaces.

It may be considered herein that PDCCH candidates corresponding to the same index at the same AL (e.g., 1, 2, 4, 8, or 16) in the two search spaces are linked. In the above example, the first PDCCH candidate (index=0) having AL 4 in search space 1 may be linked to the first PDCCH candidate (index=0) having AL 4 in search space 2, the second PDCCH candidate (index=1) having AL 4 in search space 1 may be linked to the second PDCCH candidate (index=1) having AL 4 in search space 2, and the first PDCCH candidate (index=0) having AL 8 in search space 1 may be linked to the first PDCCH candidate (index=0) having AL 8 in search space 2.

When the base station links two or more search spaces, the base station may transmit the same DCI in PDCCH candidates of the linked search spaces. For example, when first DCI may be transmitted in linked PDCCH candidates of some search spaces among linked search spaces, and second DCI is transmitted in linked PDCCH candidates of some other search spaces among the linked search spaces, the first DCI and the second DCI may not be different from each other. From the perspective of the terminal, when two or more search spaces are linked, the terminal may always expect the same DCI to be transmitted in the linked PDCCH candidates of the linked search spaces. That is, when the terminal receives first DCI from linked PDCCH candidates of some search spaces among linked search spaces, and receives second DCI from linked PDCCH candidates of some other search spaces among the linked search spaces, it may be expected that the first DCI and the second DCI are identical. In other words, when the first DCI and the second DCI are different, the terminal may determine such a case as an error case.

Under the base station operations and terminal assumptions described above, the terminal may receive linked PDCCH candidates of linked search spaces in which the same DCI is transmitted, according to the following methods.

In a first reception method, the terminal may independently or separately receive PDCCH candidates in one or some search spaces among linked search spaces. That is, although it has been configured for the terminal that the same DCI is repeatedly transmitted in the linked PDCCH candidates within the linked search spaces, the terminal may receive the DCI by blind decoding the PDCCH candidates in at least one search space. In this case, when the PDCCH candidates are blind decoded in at least one search space, only the PDCCH candidates in one or some search spaces described above may be used, without considering linked PDCCH candidates in other linked search spaces. In this manner, blind decoding is performed for each one or some search spaces, and may be thus expressed as independent or separate. For convenience, the described method may be referred to as separate PDCCH decoding. In separate PDCCH decoding, the terminal may have multiple PDCCH reception occasions using different search spaces, and when experiencing other channel environments in multiple PDCCH reception occasions, the probability of successful PDCCH reception may increase. For example, when channel environments of some search spaces among the linked search spaces are poor (e.g., when the corresponding search spaces have high interference in transmission band/time, or when the search spaces have a low reception signal-to-noise ratio (SNR) due to blocking of a transmitted TRP), the terminal may successfully receive the PDCCH in a search space with an excellent channel environment among some of the remaining search spaces. In general, separate PDCCH decoding may be suitable for transmission of the linked search spaces in different channel environments.

In a second reception method, the terminal may cooperatively or jointly receive linked PDCCH candidates in linked search spaces. For example, repeated transmission of the same DCI in the linked PDCCH candidates of the linked search spaces is configured, so that the terminal may receive the DCI by soft-combining and blind decoding determination values (e.g., log-likelihood ratio (LLR) values or similar determination values used during decoding) of the linked PDCCH candidates in the linked search spaces. In this case, since the terminal performs blind decoding using the linked PDCCH candidates of all linked search spaces, the described method may be expressed to be cooperative or joint. Hereinafter, the method may be referred to as joint PDCCH decoding. Since the base station always transmits the same DCI repeatedly in the linked PDCCH candidates in the linked search space, the terminal may perform joint PDCCH decoding. With joint PDCCH decoding, the terminal receives the same DCI multiple times, so it can benefit from the SNR gain (or channel code gain) due to multiple iterations, as well as the gain due to different channel environments that individual PDCCH decoding provides.

The terminal may perform PDCCH blind decoding by selectively using either separate PDCCH decoding or joint PDCCH decoding. Alternatively, the terminal may perform PDCCH blind decoding using both separate PDCCH decoding and joint PDCCH decoding. The PDCCH blind decoding method of the terminal is determined according to implementation of the terminal. It may be difficult for the base station to force the terminal to perform PDCCH blind decoding by using a specific method or by using both methods. In other words, the base station may configure repeated transmission of the same DCI in the linked PDCCH candidates in the linked search spaces, but the terminal may perform PDCCH blind decoding using some or all of the linked search spaces. Thus, it may be difficult for the base station to recognize which PDCCH blind decoding method the terminal uses.

Hereinafter, descriptions are provided for terminal operations in a situation where two search spaces (e.g., search space 1 and search space 2) are linked, but extension may be made to a situation where two or more search spaces are linked.

Although the terminal successfully receives DCI in a specific situation, there may be when time-frequency resources (i.e., CCEs) used for reception of a PDCCH including the DCI cannot be determined. In the following description, the described situation may be referred to as an AL8/AL16 ambiguity situation.

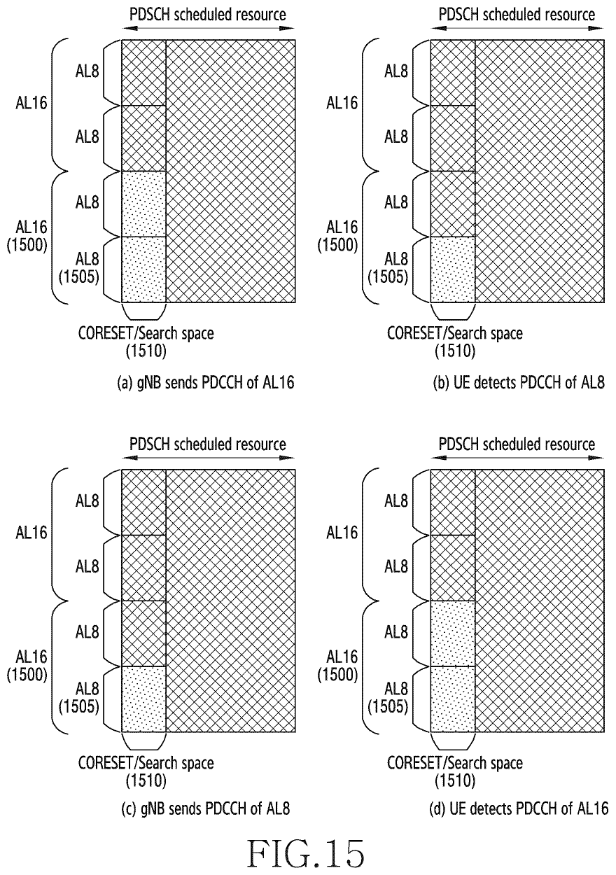

FIG. 15 illustrates a PDCCH candidate with AL 8 and a PDCCH candidate with AL 16 in one search space according to an embodiment.

Referring to sections (a), (b) and (c) in FIG. 15, a base station may configure a 1-symbol length CORESET 1510 for a terminal, and the CORESET may be configured with non-interleaved mapping. The base station may configure, for the terminal, a search space 1510 belonging to the CORESET. The search space may include at least one PDCCH candidate 1505 with AL 8 and at least one PDCCH candidate 1500 with AL 16. That is, the terminal may blind decode at least one PDCCH candidate with AL 8 and at least one PDCCH candidate with AL 16 in the search space.

Referring to section (a), the base station may transmit DCI for PDSCH scheduling, via the PDCCH candidate 1500 with AL 16. In this case, the PDCCH candidate may include a total of 16 CCEs, and time-frequency resources corresponding to the 16 CCEs may not be used for a PDSCH. For example, when generating and transmitting a PDSCH, the base station may not use, for PDSCH transmission, areas corresponding to the time-frequency resources corresponding to the 16 CCEs.

Referring to section (b), the terminal may perform blind decoding of the PDCCH candidate 1505 with AL 8 and the PDCCH candidate 1500 with AL 16 in the search space. In this case, if a start CCE index of the PDCCH candidate with AL 8 is the same as a start CCE index of the PDCCH candidate with AL 16, the terminal may receive DCI via PDCCH with AL 8. That is, when a signal-to-noise ratio is excellent in eight CCEs corresponding to the AL 8 PDCCH candidate, or when interference is strong in the remaining eight CCEs, there is a probability that, although the base station transmits the DCI via the AL 16 PDCCH candidate, decoding may be performed using the AL 8 PDCCH candidate. In this case, since the terminal has received the DCI for PDSCH scheduling, via the AL 8 PDCCH candidate, it may be assumed that the terminal may not use, for PDSCH reception, 8 CCEs corresponding to the AL 8 PDCCH candidate. Accordingly, the terminal may receive the PDSCH in resource areas remaining after excluding the time-frequency resource areas of the 8 CCEs. Since the PDSCH transmitted from the base station and the PDSCH received by the terminal are transmitted/received in different resource areas, it may be difficult for the terminal to successfully receive the PDSCH.

Referring to section (c), the base station may transmit DCI for PDSCH scheduling, via the PDCCH candidate 1505 with AL 8. In this case, the PDCCH candidate may include a total of 8 CCEs, and time-frequency resources corresponding to the 8 CCEs may not be used for a PDSCH. That is, when generating and transmitting a PDSCH, the base station may not use, for PDSCH transmission, areas corresponding to the time-frequency resources corresponding to the 8 CCEs.

Referring to section (d), the terminal may perform blind decoding of the PDCCH candidate 1505 with AL 8 and the PDCCH candidate 1500 with AL 16 in the search space. In this case, if the start CCE index of the PDCCH candidate with AL 8 is the same as the start CCE index of the PDCCH candidate with AL 16, the terminal may receive DCI via PDCCH with AL 16. That is, when an SNR is excellent in eight CCEs corresponding to the AL 8 PDCCH candidate, and a signal-to-noise ratio is low in the remaining eight CCEs, there is a probability that, although the base station transmits the DCI via the AL 8 PDCCH candidate, decoding may be performed using the AL 16 PDCCH candidate. In this case, since the terminal has received the DCI for PDSCH scheduling, via the AL 16 PDCCH candidate, it may be assumed that the terminal may not use, for PDSCH reception, 16 CCEs corresponding to the AL 16 PDCCH candidate. Accordingly, the terminal may receive the PDSCH in resource areas remaining after excluding the time-frequency resource areas of the 16 CCEs. In this case, since the PDSCH transmitted from the base station and the PDSCH received by the terminal are transmitted/received in different resource areas, it may be difficult for the terminal to successfully receive the PDSCH.

In this manner, the PDCCH candidate via which the base station transmits the DCI may not be the same as the PDCCH candidate via which the terminal receives the DCI. Therefore, PDSCH rate matching of the terminal may be affected. To this end, 3GPP Rel-15 defines the following terminal operations.

3GPP Rel-15 terminal operation: When CORESET is configured with 1-symbol and non-interleaved mapping, and the terminal monitors the AL 8 PDCCH candidate and the AL 16 PDCCH candidate starting from the same CCE index, and when the DCI for PDSCH scheduling is received in the AL 8 PDCCH candidate, the terminal may not use, for PDSCH reception, the time-frequency resources corresponding to the AL 16 PDCCH candidate.

In the 3GPP Rel-15 terminal operation, when there is ambiguity between AL 8 and AL 16, it may be assumed that the terminal has performed reception at AL 16 which is the greater AL of the two. When it is assumed that the reception has been performed at AL 16, the PDSCH cannot use the time-frequency resources of the AL 16 PDCCH candidate, resulting in resource loss. However, misunderstandings about PDSCH rate matching between the base station and the terminal may be prevented.

The 3GPP Rel-15 terminal operation will be described with reference to FIG. 15. The terminal may monitor the PDCCH candidate 1505 with AL 8 and the PDCCH candidate 1510 with AL 16 starting from the same CCE 1520 in the search space 1500. In section (a), if the terminal receives DCI for PDSCH scheduling in the PDCCH candidate 1505 with AL 8, the terminal may not use, for PDSCH reception, time-frequency resources 1530 corresponding to PDCCH with AL 16. In FIG. 15B, if the terminal receives DCI for PDSCH scheduling in the PDCCH candidate 1510 with AL 16, the terminal may not use, for PDSCH reception, time-frequency resources 1535 corresponding to PDCCH with AL 16. Based on section (a) and section (b), even if the terminal receives DCI for PDSCH scheduling, in a PDCCH candidate with a certain AL, the same resource is not used for PDSCH transmission, so that misunderstandings about PDSCH rate mapping between the base station and the terminal may be prevented.

### Embodiment 3: RB Set Determination Method in Consideration of AL8/AL16

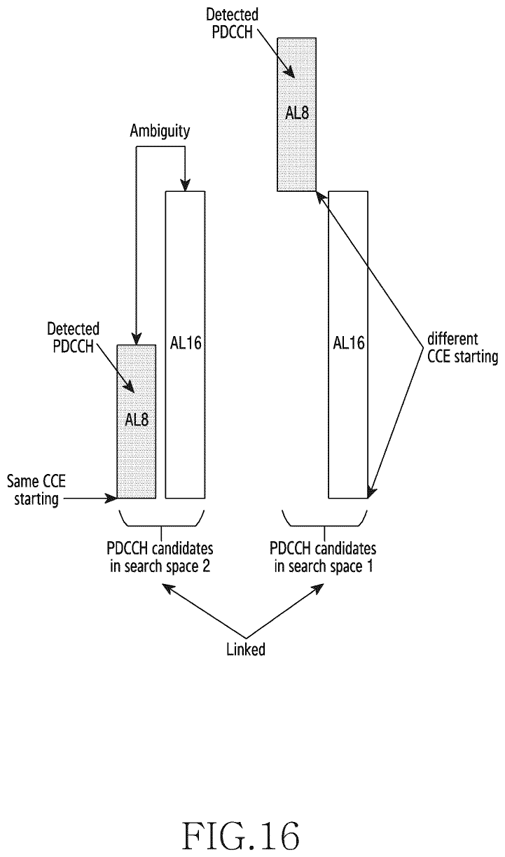

FIG. 16 illustrates a PDCCH candidate with AL 8 and a PDCCH candidate with AL 16 in two linked search spaces.

Referring to FIG. 16, descriptions may be provided for a situation in which a PDCCH candidate with AL 8 (1605) and a PDCCH candidate with AL 16 (1610) exist in two linked search spaces. In this case, in one search space, the PDCCH candidate with AL 8 (1605) and the PDCCH candidate with AL 16 (1610) have the same start CCE, but in the other linked search space, the PDCCH candidate with AL 8 (1605) and the PDCCH candidate with AL 16 (1610) may have different start CCEs. Since the PDCCH candidate with AL 8 (1605) and the PDCCH candidate with AL 16 (1610) have the same start CCE, the PDCCH candidate received by a terminal may have either AL 8 (1605) or AL 16 (1610). That is, from the perspective of the terminal, it may be ambiguous via which PDCCH candidate a DCI format has been received.

The terminal may monitor DCI format 0_0 for PUSCH scheduling in a common search space (CSS). DCI format 0_0 may be transmitted repeatedly in the two linked search spaces. The terminal may determine an UL RB set scheduled by DCI format 0_0. The terminal may determine, as a scheduled UL RB set, an RB set having the lowest index among RB sets overlapping with a CCE having the lowest index of a PDCCH including DCI format 0_0.

To determine a scheduled UL RB set, the terminal may determine an RB set, based on the PDCCH candidate monitored in the search space with the lower index among the two linked search spaces. For example, when DCI format 0_0 received by the terminal is monitored via the two linked search spaces, the terminal may determine the PDCCH candidate monitored in the search space with the lower index among the two linked search spaces, and may determine a scheduled UL RB set, based on a CCE having the lowest index of the PDCCH candidate.

It is assumed that the terminal is monitoring the PDCCH candidate with AL 8 (1605) and the PDCCH candidate with AL 16 (1610) in the search space with the low index. DCI format 0_0 may be received via one of the two PDCCH candidates. If start CCE indexes of the two PDCCH candidates in the search space with low index are the same, the terminal may determine a scheduled UL RB set based on the start CCE index. If the start CCE indexes of the two PDCCH candidates in the search space with the low index are not the same, but the start CCE indexes of the two PDCCH candidates in the linked search space with the high index are the same, it may be ambiguous as to which CCE among the lowest CCE of the PDCCH candidate with AL 8 (1605) and the lowest CCE of the PDCCH candidate with AL 16 (1610) in the search space with the low index is used as a basis for the terminal to determine a scheduled UL RB set.

The terminal may determine an RB set, based on the PDCCH candidate with the higher AL (i.e., AL 16 (1610)). For example, among the CCE having the lowest index of the PDCCH with AL 8 (1605) and the CCE having the lowest index of the PDCCH with AL 16 (1610), the terminal may select the CCE having the lowest index of the PDCCH with AL 16 (1610). The terminal may determine that an RB set with the lowest index among UL RB sets overlapping with the selected CCE is a scheduled UL RB set. The terminal may transmit a PUSCH to a base station in the determined RB set.

The base station may receive the PUSCH from the terminal in the RB set with the lowest index among the UL RB sets overlapping with the CCE having the lowest index of the PDCCH with AL 16 (1610).

The terminal may determine an RB set, based on the PDCCH candidate with the lower AL (i.e., AL 8 (1605)). For example, among the CCE having the lowest index of the PDCCH with AL 8 (1605) and the CCE having the lowest index of the PDCCH with AL 16 (1610), the terminal may select the CCE having the lowest index of the PDCCH with AL 8 (1605). The terminal may determine that an RB set with the lowest index among UL RB sets overlapping with the selected CCE is a scheduled UL RB set. The terminal may transmit a PUSCH to the base station in the determined RB set.

The base station may receive the PUSCH from the terminal in the RB set with the lowest index among the UL RB sets overlapping with the CCE having the lowest index of the PDCCH with AL 8 (1605).

The terminal may determine an RB set, based on a CCE located at a lower frequency in the frequency domain among the CCEs having the lowest indexes of the two PDCCH candidates. Among the CCE having the lowest index of the PDCCH with AL 8 (1605) and the CCE having the lowest index of the PDCCH with AL 16 (1610), the terminal may determine a CCE located at the lower frequency in the frequency domain. The terminal may determine that an RB set with the lowest index among the UL RB sets overlapping with the selected CCE is a scheduled UL RB set. The terminal may transmit a PUSCH to the base station in the determined RB set.

The base station may receive the PUSCH from the terminal in the RB set with the lowest index among the UL RB sets overlapping with the CCE located at the lower frequency in the frequency domain among the CCEs having the lowest indexes of the two PDCCH candidates.

The terminal may determine that an RB set with the lowest index among RB sets overlapping with the CCEs having the lowest index of the two PDCCH candidates is a scheduled UL RB set. The terminal may determine first RB sets overlapping with the CCE having the lowest index of the PDCCH with AL 8 (1605) and second RB sets overlapping with the CCE having the lowest index of the PDCCH with AL 16 (1610). The terminal may determine that an RB set with the lowest index among the first RB sets and the second RB sets is a scheduled UL RB set. The terminal may transmit a PUSCH to the base station in the determined RB set.

The base station may receive the PUSCH from the terminal in the RB set having the lowest index among the RB sets overlapping with the CCEs having the lowest index of the two PDCCH candidates, respectively.

In the search space with the low index, if the CCE having the lowest index of the PDCCH with AL 8 (1605) and the CCE having the lowest index of the PDCCH with AL 16 (1610) are the same, the terminal may determine a scheduled RB set based on the CCEs. However, in the search space with the low index, if the CCE having the lowest index of the PDCCH with AL 8 (1605) and the CCE having the lowest index of the PDCCH with AL 16 (1610) are different from each other, the terminal may determine RB set 0 as a scheduled UL RB set. For example, if the terminal is unable to determine an RB set based on one CCE when AL8 (1605)/AL16 ambiguity occurs, the terminal may not determine an RB set based on the CCE, and may determine RB set 0 as a scheduled UL RB set.

The terminal may determine a scheduled UL RB set, based on the search space in which the CCE having the lowest index of the PDCCH with AL 8 (1605) and the CCE having the lowest index of the PDCCH with AL 16 (1610) are the same. For example, in the method above, the CCEs having the lowest index of the PDCCH candidate with AL 8 (1605) and the PDCCH candidate with AL 16 (1610) in the search space having the low index may be different from each other, and the CCEs having the lowest index of the PDCCH candidate with AL 8 (1605) and the PDCCH candidate with AL 16 (1610) in the linked search space having the high index may be the same. In this case, the terminal may determine the CCE having the lowest index of the PDCCH candidate with AL 8 (1605) and the PDCCH candidate with AL 16 (1610) monitored in the search space with the high index. The terminal may determine a scheduled UL RB set, based on the CCE. For example, the terminal may determine, as a scheduled UL RB set, an RB set with the lowest index among UL RB sets overlapping with the determined CCE in the search space with the high index.

The terminal may determine UL RB set(s), based on each of CCEs of the PDCCH candidate with AL 8 (1605) and the PDCCH candidate with AL 16 (1610) monitored in the search space with the low index. If the UL RB set(s) determined based on each of the two CCEs are the same so as to be one RB set, the terminal may determine the one RB set as a scheduled UL RB set. If the UL RB set(s) determined based on each of the two CCEs are different RB sets, the terminal may determine that two RB sets are scheduled UL RB sets when the two RB sets have consecutive indexes. If the two RB sets do not have consecutive indexes, the terminal may select one of the two RB sets. For example, one RB set may be selected based on the PDCCH candidate with AL 8 (1605) or AL 16 (1610).

For DCI format 0_0, a PUSCH is scheduled in only one RB set, but in this method, a PUSCH may be scheduled in up to two RB sets.

The terminal may always expect a PUSCH to be scheduled in only one RB set via DCI format 0_0. For example, the terminal may determine UL RB set(s), based on each of the CCEs of the PDCCH candidate with AL 8 (1605) and the PDCCH candidate with AL 16 (1610) monitored in the search space with the low index. If the UL RB set(s) determined based on each of the two CCEs are the same so as to be one RB set, the terminal may determine the one RB set as a scheduled UL RB set. If the UL RB set(s) determined based on each of the two CCEs are different RB sets, the terminal may determine such a case as an error case. For example, the terminal may not monitor the PDCCH candidate with AL 8 (1605) and the PDCCH candidate with AL 16 (1610), in which two different RB sets are likely to be indicated, even if the PDCCH candidates are configured to be monitored. The base station may not transmit DCI format 0_0 to the PDCCH candidate with AL 8 (1605) and the PDCCH candidate with AL 16 (1610), in which two different RB sets are likely to be indicated, in the two linked search spaces configured to be monitored by the terminal.

To avoid AL8/AL16 ambiguity, the terminal may expect that an UL BWP corresponding to an active DL BWP monitoring DCI format 0_0 will always include only one RB set. For example, if the terminal is configured to monitor the PDCCH candidate with AL 8 (1605) and the PDCCH candidate with AL 16 (1610) in the two linked search spaces, the terminal may expect that an active UL BWP always includes only one RB set. If the terminal is configured to monitor only one of the PDCCH candidate with AL 8 (1605) and the PDCCH candidate with AL 16 (1610) in the two linked search spaces, the active UL BWP of the terminal may include one or more one RB sets. If the base station configures the terminal to monitor the PDCCH candidate with AL 8 (1605) and the PDCCH candidate with AL 16 (1610) in the two linked search spaces, the base station may configure the active UL BWP of the terminal to always include only one RB set.

### SBFD Operations

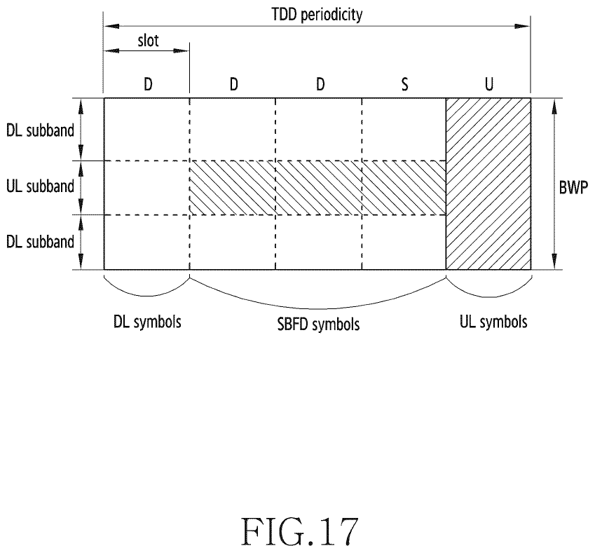

FIG. 17 illustrates SBFD operations according to an embodiment.

Referring to FIG. 17, according to TDD configurations, a UL symbol, a DL symbol, or a flexible symbol may be configured for a terminal. In this case, in a D slot 1720, all symbols in the slot 1720 may be DL symbols 1725. In a U slot 1720, all symbols in the slot 1720 may be UL symbols 1730. An S slot 1720 may be a slot 1720 other than a D slot 1720 or a U slot 1720. A UL BWP may be configured for the terminal. In addition, a UL subband 1710 within a DL symbol 1725 may be configured for the terminal. Also, a slot 1720 or a symbol to apply a UL subband 1710 may be configured for the terminal. Referring to FIG. 17, a UL subband 1710 may be applied in only some symbols among DL symbols 1725 of a TDD periodicity 1715. A UL subband 1710 is applied in DL symbols 1725 of second and third slot 1720s, but no UL subband 1710 may be applied in other DL symbols. In this case, an SBFD symbol may represent a symbol in which a UL subband 1710 is applied.

### Embodiment 4: RB Set Determination Method During SBFD Operation

The terminal may include N RB sets in a UL BWP. However, N RB sets are all included in the UL BWP in a UL symbol 1730, but some thereof may not be included in a UL subband 1710 in an SBFD symbol. Depending on a symbol type scheduled for the terminal, RB sets available for scheduling may be different.

Furthermore, a PDCCH including DCI for PUSCH scheduling may be received in a DL subband 1705, and the DCI may schedule a PUSCH in a UL subband 1710. For DCI format 0_0 monitored in CSS, the terminal may determine, as scheduled UL RB sets, RB sets having the lowest index among UL RB sets overlapping with a CCE having the lowest index of the PDCCH including DCI format 0_0. However, the UL RB sets overlapping with the CCE are RB sets included in a UL symbol, but may be RB sets not included in a UL subband 1710. A method for solving the problem described above is disclosed.

Herein, when the terminal receives DCI for PUSCH scheduling, a slot 1720 or a symbol, in which a PUSCH scheduled by the DCI is transmitted, may be determined. If the slot 1720 or symbol includes at least one SBFD symbol, the terminal may determine that one of RB sets included in a UL subband 1710 is a scheduled UL RB set. Hereinafter, for convenience, the RB sets included in the UL subband 1710 may be referred to as first RB sets. For example, the terminal may determine that a first RB set having the lowest index among first RB sets overlapping with a CCE having the lowest index of the PDCCH received by the terminal is a scheduled RB set. If there are no first RB sets overlapping with the CCE having the lowest index of the PDCCH received by the terminal, the terminal may determine that an RB set having the lowest index among the first RB sets is a scheduled UL RB set.

If both the slot 1720 and symbol include only UL symbols, the terminal may determine that one of RB sets included in the UL BWP is a scheduled UL RB set. Hereinafter, the RB sets included in the UL BWP may be referred to as second RB sets. For example, the terminal may determine that a second RB set having the lowest index among second RB sets overlapping with the CCE having the lowest index of the PDCCH received by the terminal is a scheduled RB set. If there are no second RB sets overlapping with the CCE having the lowest index of the PDCCH received by the terminal, the terminal may determine that an RB set having the lowest index among the second RB sets, that is, RB set 0, is a scheduled UL RB set.

The terminal may receive, via a DCI format, an indication of PUSCH repetition transmission. In this case, the terminal may determine an UL RB set in which the PUSCH is transmitted in each slot 1720. Hereinafter, herein a description will be provided for a method of determining a UL RB set in which the PUSCH is transmitted in each slot 1720.

In a first method, when PUSCH repetition transmission is indicated via the DCI format, the terminal may always determine an UL RB set, based on first PUSCH transmission, and for subsequent transmission, the terminal may perform PUSCH repetition transmission in the determined RB set. For example, when first PUSCH transmission overlaps with an SBFD symbol, the terminal may determine, as a scheduled UL RB set, one RB set among the first RB sets. Since the RB set is included in the second RB sets, the terminal may perform, in the RB set, PUSCH repetition transmission overlapping with only UL symbols. When the first PUSCH transmission overlaps with only UL symbols, the terminal may determine, as a scheduled UL RB set, one RB set among the second RB sets. If the selected RB set is also included in the first RB sets, the terminal may perform, in the RB set, PUSCH repetition transmission overlapping with the SBFD symbol. If the selected RB set is not included in the first RB sets, the terminal may not perform PUSCH repetition transmission overlapping with the SBFD symbol.

In a second method, when PUSCH repetition transmission is indicated to the terminal via the DCI format, if at least one PUSCH repetition transmission overlaps with an SBFD symbol, the terminal may determine, based on the first RB sets, an RB set in which PUSCH repetition transmission is to be performed, and all PUSCH repetition transmissions may be performed in the RB set. If PUSCH repetition transmission is indicated to the terminal via the DCI format, and all PUSCH repetition transmissions overlap with only UL symbols, the terminal may determine, based on the second RB sets, an RB set in which PUSCH repetition transmission is to be performed.

In a third method, when PUSCH repetition transmission is indicated to the terminal via the DCI format, the terminal may independently determine an RB set in which PUSCH repetition transmission is to be performed for each PUSCH repetition transmission. For example, when some of the PUSCH repetition transmissions overlap with an SBFD symbol, an RB set in which PUSCH repetition transmission is performed may be determined based on the first RB sets, and when some of the PUSCH repetition transmissions overlap with only UL symbols, an RB set in which PUSCH repetition transmission is performed may be determined based on the second RB sets.

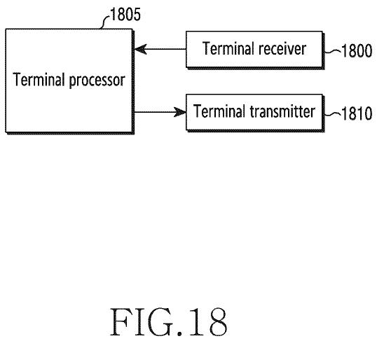

FIG. 18 illustrates a structure of a UE in a wireless communication system according to an embodiment.

Referring to FIG. 18, the UE may include a transceiver, which refers to a UE receiving unit 1800 and a UE transmitting unit 1810 as a whole, a memory, and a UE processing unit 1805 (or UE controller or processor). The UE transceiver 1800 and 1810, the memory, and the UE processing unit 1805 may operate according to the above-described communication methods of the UE. Components of the UE are not limited to the above-described example. For example, the UE may include a larger or smaller number of components than the above-described components. The transceiver, the memory, and the processor may be implemented as a single chip.

The transceiver 1800 and 1810 may transmit/receive signals with the base station. The signals may include control information and data. To this end, the transceiver 1800 and 1810 may include an RF transmitter configured to up-convert and amplify the frequency of transmitted signals, an RF receiver configured to low-noise-amplify received signals and down-convert the frequency thereof, and the like. This is only an embodiment of the transceiver 1800 and 1810, and the components of the transceiver 1800 and 1810 are not limited to the RF transmitter and the RF receiver. The transceiver 1800 and 1810 may receive signals through a radio channel, output the same to the processor 1805, and transmit signals output from the processor 1805 through the radio channel.

The memory may store programs and data necessary for operations of the UE. The memory may store control information or data included in signals transmitted/received by the UE. The memory may include storage media such as a ROM, a RAM, a hard disk, a CD-ROM, and a DVD, or a combination of storage media. The UE may include multiple memories that may store programs for executing the above-described RB set determination methods.

The processor 1805 may control a series of processes such that the UE can operate according to the above-described embodiments. For example, the processor 1805 may control components of the UE so as to receive DCI configured in two layers such that multiple PDSCHs are received simultaneously. The UE may include multiple processors 1805, and the processors may perform UE component control operations by executing the programs stored in the memory. The processor 1805 may control the UE components to perform the embodiments of the disclosure by executing the programs stored in the memory. The processor 1805 may be an application processor (AP), a communication processor (CP), a circuit, an application-specific circuit, or at least one processor.

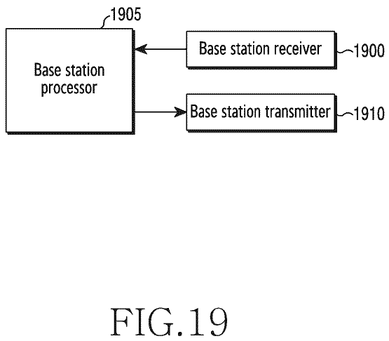

FIG. 19 illustrates a structure of a base station in a wireless communication system according to an embodiment.

Referring to FIG. 19, the base station may include a transceiver, which refers to a base station receiving unit 1900 and a base station transmitting unit 1910 as a whole, a memory, and a base station processing unit 1905 (or base station controller or processor). The base station transceiver 1900 and 1910, the memory, and the base station processing unit 1905 may operate according to the above-described communication methods of the base station. Components of the base station are not limited to the above-described example. For example, the base station may include a larger or smaller number of components than the above-described components. The transceiver, the memory, and the processor may be implemented as a single chip.

The transceiver 1900 and 1910 may transmit/receive signals with the UE. The signals may include control information and data. To this end, the transceiver 1900 and 1910 may include an RF transmitter configured to up-convert and amplify the frequency of transmitted signals, an RF receiver configured to low-noise-amplify received signals and down-convert the frequency thereof, and the like. This is only an embodiment of the transceiver 1900 and 1910, and the components of the transceiver 1900 and 1910 are not limited to the RF transmitter and the RF receiver. The transceiver 1900 and 1910 may receive signals through a radio channel, output the same to the processor 1905, and transmit signals output from the processor 1905 through the radio channel.

The memory may store programs and data necessary for operations of the base station. The memory may store control information or data included in signals transmitted/received by the base station. The memory may include storage media such as a ROM, a RAM, a hard disk, a CD-ROM, and a DVD, or a combination of storage media. The base station may include multiple memories that may store programs for executing the above-described RB set determination methods.

The processor 1905 may control a series of processes such that the base station can operate according to the above-described embodiments. For example, the processor 1905 may control components of the base station so as to configure DCI configured in two layers including allocation information regarding multiple PDSCHs and to transmit the same. The base station may include multiple processors, and the processors may perform the base station component control operations by executing the programs stored in the memory. The processor 1905 may control the UE components to perform the embodiments of the disclosure by executing the programs stored in the memory. The processor 1905 may be an application processor (AP), a communication processor (CP), a circuit, an application-specific circuit, or at least one processor.

It should be noted that the above-described configuration diagrams, illustrative diagrams of control/data signal transmission methods, illustrative diagrams of operation procedures, and structural diagrams as illustrated in FIG. 1 to FIG. 19 are not intended to limit the scope of protection of the disclosure. That is, all the constituent elements, entities, or operation steps shown and described in FIG. 1 to FIG. 19 should not be construed as being essential elements for the implementation of the disclosure, and even when including only some of the elements, the disclosure may be implemented without impairing the true of the disclosure.

The methods according to the embodiments described herein may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described herein.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

The program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment;

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Although the above embodiments have been presented based on the frequency division duplex (FDD) LTE system, other variants based on the technical idea of the above embodiments may also be implemented in other systems such as time division duplex (TDD) LTE, 5G, or NR systems.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a terminal in a wireless communication system, the method comprising:
receiving, from the base station, a physical downlink control channel (PDCCH) including at least one control channel element (CCE); and
identifying a resource block (RB) set for an uplink transmission based on the PDCCH in case that a CCE with a first lowest index is overlapped with a guard band in a plurality of RB sets.

2. The method of claim 1,
wherein the RB set is identified based on a CCE with a second lowest index or is a RB set with a lowest index among the plurality of RB sets including the guard band.

3. The method of claim 1,
wherein the RB set is configured by the base station.

4. The method of claim 1,
wherein the PDCCH is monitored in a common search space (CSS) or a user equipment (UE) specific search space (USS).

5. The method of claim 2, wherein information for the RB set with the lowest index is not included in downlink control information (DCI) on the PDCCH monitored in a USS.

6. A method performed by a base station in a wireless communication system, the method comprising:
transmitting, to a terminal, a physical downlink control channel (PDCCH) including at least one control channel element (CCE),
wherein a resource block (RB) set for an uplink transmission is based on the PDCCH in case that a CCE with a first lowest index is overlapped with a guard band in a plurality of RB sets.

7. The method of claim 6,
wherein the RB set is based on a CCE with a second lowest index or is a RB set with a lowest index among the plurality of RB sets including the guard band.

8. The method of claim 6,
wherein the RB set is configured to the terminal.

9. The method of claim 6,
wherein the PDCCH is associated with a common search space (CSS) or a user equipment (UE) specific search space (USS).

10. The method of claim 7,
wherein information for indicating the RB set with the lowest index is not included in downlink control information (DCI) on the PDCCH associated with a USS.

11. A terminal in a wireless communication system, the terminal comprising:
a transceiver; and
at least one processor coupled with the transceiver and configured to:
receive, from the base station, a physical downlink control channel (PDCCH) including at least one control channel element (CCE), and
identify a resource block (RB) set for an uplink transmission based on the PDCCH in case that a CCE with a first lowest index is overlapped with a guard band in a plurality of RB sets.

12. The terminal of claim 11,
wherein the RB set is identified based on a CCE with a second lowest index or is a RB set with a lowest index among the plurality of RB sets including the guard band.

13. The terminal of claim 11,
wherein the RB set is configured by the base station.

14. The terminal of claim 11,
wherein the PDCCH is monitored in a common search space (CSS) or a user equipment (UE) specific search space (USS).

15. The terminal of claim 12,
wherein information for the RB set with the lowest index is not included in downlink control information (DCI) on the PDCCH monitored in a USS.

16. A base station in a wireless communication system, the base station comprising:
a transceiver; and
at least one processor coupled with the transceiver and configured to:
transmit, to a terminal, a physical downlink control channel (PDCCH) including at least one control channel element (CCE),
wherein a resource block (RB) set for an uplink transmission is based on the PDCCH in case that a CCE with a first lowest index is overlapped with a guard band in a plurality of RB sets.

17. The base station of claim 16,
wherein the RB set is based on a CCE with a second lowest index or is a RB set with a lowest index among the plurality of RB sets including the guard band.

18. The base station of claim 16,
wherein the RB set is configured to the terminal.

19. The base station of claim 16, wherein the PDCCH is associated with a common search space (CSS) or a user equipment (UE) specific search space (USS).

20. The base station of claim 17, wherein information for indicating the RB set with the lowest index is not included in downlink control information (DCI) on the PDCCH associated with a USS.
